(19) United States
(12) Patent Application Publication
(10) Pub. No.: US 2016/0244066 A1
(43) Pub. Date: Aug. 25, 2016

(54) COMPUTER PRODUCT, UNEVENNESS ANALYSIS METHOD, AND UNEVENNESS ANALYZER

(71) Applicant: FUJITSU LIMITED, Kawasaki-shi (JP)

(72) Inventors: Hiroyuki TANI, Katsushika (JP); SHIN TOTOKI, Oita (JP)

(73) Assignee: FUJITSU LIMITED, Kawasaki-shi (JP)

(21) Appl. No.: 15/147,026

(22) Filed: May 5, 2016

Related U.S. Application Data
(63) Continuation of application No. PCT/JP2014/079893, filed on Nov. 11, 2014.

(30) Foreign Application Priority Data
Nov. 12, 2013 (JP) 2013-234480

(51) Int. Cl. B60W 40/06; G01B 7/34; G01P 15/00

(52) U.S. Cl. CPC B60W 40/06; G01P 15/00; G01B 7/345; B60W 2520/105; B60W 2520/125

(57) ABSTRACT

A non-transitory, computer-readable recording medium stores therein an unevenness analysis program that causes a computer to perform based on an analysis parameter, analysis of motion data of a mobile object and analysis of unevenness of a road surface traveled by the mobile object. The unevenness analysis program causes the computer to execute a process including identifying based on a motion status of the mobile object indicated by the motion data, which includes at least longitudinal acceleration of the mobile object, first motion data that indicates one of an accelerating state and a decelerating state of the mobile object; and executing with respect to the identified first motion data indicating one of an accelerating state and a decelerating state, a comparison with second motion data not indicating one of an accelerating state and a decelerating state, and detection of unevenness of the road surface by a reduced sensitivity.

### CROSS REFERENCE TO RELATED APPLICATIONS

This is a continuation application of International Application PCT/JP2014/079893 filed on Nov. 11, 2014 which claims priority from a Japanese Patent Application No. 2013-234480 filed on Nov. 12, 2013, the contents of which are incorporated herein by reference.

### FIELD

The embodiments discussed herein are related to a computer product, an unevenness analysis method, and an unevenness analyzer.

### BACKGROUND

Road surfaces are degraded by the load of vehicles such as automobiles and motorcycles and the forces of nature and aging whereby, unevenness may occur. For example, obstacles such cracks or depressions in road surfaces or cracks resulting from an earthquake cause unevenness in a road surface. Unevenness in a road surface affects the safety of vehicles traveling on the road surface and therefore, is desirably detected and remediated at an early stage.

According to a related technique, for example, changes in acceleration resulting from vibrations from the road surface, impact from the road surface, etc. are sensed, vehicular position is determined by obtaining GPS positioning information and GPS positioning error, and vibration information and position information concerning the location are associated with map information and recorded. According to a further technique, changes in acceleration are obtained by an accelerometer according to speed, a correlation function of an internally stored event occurrence determination pattern and an obtained pattern of acceleration change is determined, and the degree of correlation thereof is checked. According another related technique, whether a recording condition is satisfied is determined based on a threshold and a signal from a sensor that detects acceleration of a vehicular, whether the vehicle is traveling along a curve is discriminated based on current position information, and when the vehicle has been determined to be traveling along a curve, a relation of the threshold and the signal from the sensor is adjusted. For examples of related techniques, refer to Japanese Laid-Open Patent Publication Nos. 2001-4382, 2012-64126, and 2010-61681

### SUMMARY

According to an aspect of an embodiment, a non-transitory, computer-readable recording medium stores therein an unevenness analysis program that causes a computer to perform based on an analysis parameter, analysis of motion data of a mobile object and analysis of unevenness of a road surface traveled by the mobile object. The unevenness analysis program causes the computer to execute a process including identifying based on a motion status of the mobile object indicated by the motion data, which includes at least longitudinal acceleration of the mobile object, first motion data that indicates one of an accelerating state and a decelerating state of the mobile object; and executing with respect to the identified first motion data indicating one of an accelerating state and a decelerating state, a comparison with second motion data not indicating one of an accelerating state and a decelerating state, and detection of unevenness of the road surface by a reduced sensitivity.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an example of an unevenness analysis method according to a first embodiment, for road surfaces;

FIG. 2 is a diagram depicting an example of system configuration of a system 200;

FIG. 3 is a block diagram of an example of hardware configuration of an unevenness analyzer 201;

FIG. 4 is a block diagram of an example of hardware configuration of a travel data measuring device 202;

FIG. 5 is a diagram depicting one example of the contents of travel data 500;

FIG. 6 is a diagram depicting one example of the contents of analysis parameters 600;

FIG. 7 is a diagram depicting one example of the contents of an unevenness analysis table 700;

FIG. 8 is a block diagram of an example of a functional configuration of the unevenness analyzer 201;

FIG. 9 is a diagram depicting an example of the unevenness analysis method according to a second embodiment, for road surfaces;

FIG. 10 is a flowchart (part 1) of an example of a procedure of a road surface unevenness analysis process;

FIG. 11 is a flowchart (part 2) of an example of a procedure of the road surface unevenness analysis process;

FIG. 12 is a flowchart (part 3) of an example of a procedure of the road surface unevenness analysis process;

FIG. 13 is a flowchart (part 4) of an example of a procedure of the road surface unevenness analysis process; and

FIG. 14 is a flowchart (part 5) of an example of a procedure of the road surface unevenness analysis process.

### DESCRIPTION OF EMBODIMENTS

Embodiments of an unevenness analysis program, an unevenness analysis method, and an unevenness analyzer according to the present invention will be described in detail with reference to the accompanying drawings.

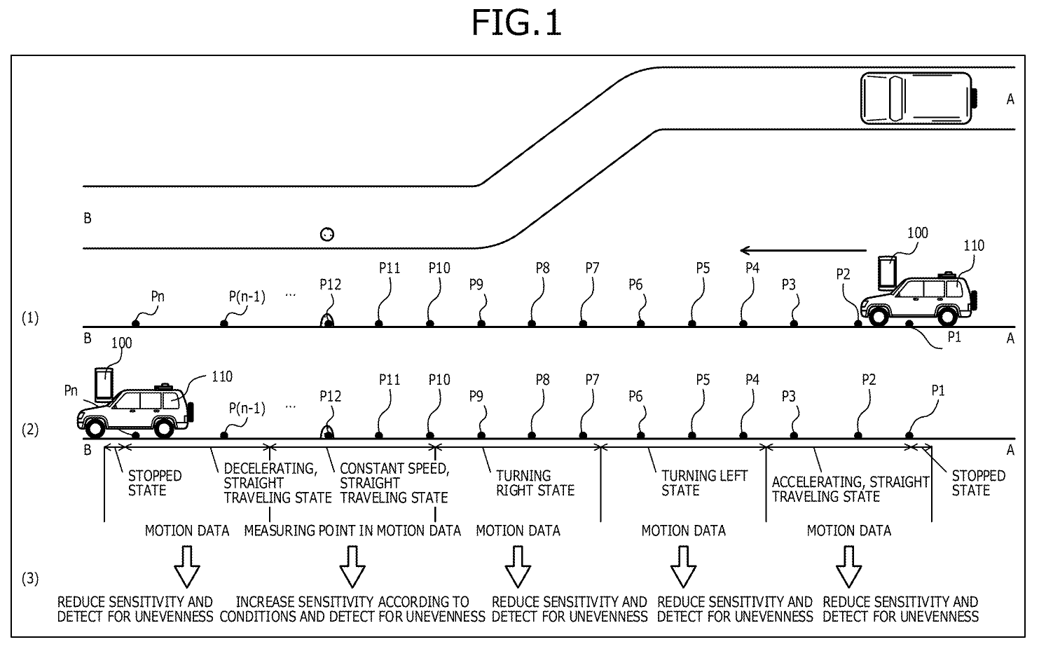

FIG. 1 is a diagram depicting an example of the unevenness analysis method according to a first embodiment, for road surfaces. In FIG. 1, an unevenness analyzer 100 is a computer that based on an analysis parameter, analyzes motion data of a mobile object 110 and analyzes the unevenness of a road surface traveled by the mobile object 110.

Here, the mobile object 110 is an object capable of powered motion on a road surface by, for example, an internal combustion engine, a battery, and human power. For example, the mobile object 110 is a vehicle such as an automobile, a motorcycle, and a bicycle that uses wheels to move on a road surface, or a snowmobile that uses rails to move on the surface of snow. Further, a road surface is the surface of a road. A road surface further includes snow surfaces and ice surfaces.

Road surface unevenness is an unlevel portion on a road surface. For example, in an uneven road surface, depressions and cracks occurring from degradation of the road surface over time and consequent to vehicular load are present. Further, an uneven road surface has cracks caused by natural forces such as earthquakes, debris such as rocks put on the road by natural forces or human actions, and artificially created objects. Artificially created unevenness, for example, includes crosswalks painted on road surfaces, manhole covers disposed for the maintenance of sewers, and the like.

Motion data of the mobile object 110 is data that indicates the motion status of the mobile object 110. The motion status of the mobile object 110 represents changes in the moving state of the mobile object 110. The moving state, for example, may be a stopped state, an accelerating state, a decelerating state, a constant speed state, a turning right state, a turning left state, a straight traveling state, and the like. The stopped state is when the mobile object 110 is stopped, i.e., the speed of the mobile object 110 is 0. The accelerating state is when the velocity of the mobile object 110 increasing. The decelerating state is when the velocity of the mobile object 110 is decreasing. The constant speed state is when the speed of the mobile object 110 is substantially constant. The turning right state is when the mobile object 110 is turning right, when acceleration in the rightward direction of the mobile object 110 is a predetermined value or greater. The turning left state is when the mobile object 110 is turning left, when acceleration in the leftward direction of the mobile object 110 is a predetermined value or greater. The straight traveling state is when the mobile object 110 is not in the turning left state or the turning right state.

In the description hereinafter, a state combining the accelerating state and the straight traveling state may be indicated as an “accelerating, straight traveling state”. Further, a state combining the decelerating state and the straight traveling state may be indicated as a “decelerating, straight traveling state”. A state combining the constant speed state and the straight traveling state may be indicated as a “constant speed, straight traveling state”.

The motion data of the mobile object 110 includes, for example, information such as measurement position, measurement time, a measured acceleration value obtained periodically or on an irregular basis by an accelerometer equipped on the mobile object 110. Further, acceleration of the mobile object 110, for example, may be acceleration in a forward or backward direction of the mobile object 110, acceleration in a leftward or rightward direction of the mobile object 110, and acceleration in an upward or downward direction of the mobile object 110.

In the description hereinafter, acceleration in a forward or backward direction of the mobile object 110 may be indicated as “longitudinal acceleration”. Acceleration in a leftward or rightward direction of the mobile object 110 may be indicated as “lateral acceleration”. Acceleration in an upward or downward direction of the mobile object 110 may be indicated as “vertical acceleration”.

Acceleration in the respective directions, for example, is measured by sensors configured to measure acceleration in the respective directions. Further, for example, the unevenness analyzer 100 may measure longitudinal, lateral, and vertical acceleration of the mobile object 110 by performing vector analysis of the measured values obtained by sensors configured to measure acceleration in oblique directions of the mobile object 110.

An analysis parameter is a parameter for analyzing road surface unevenness from motion data of the mobile object 110. The analysis parameter includes a measuring threshold of the accelerometer. The measuring threshold of the accelerometer is a threshold used by the unevenness analyzer 100 to detect road surface unevenness. The unevenness analyzer 100, for example, compares the measuring threshold of the accelerometer and vertical acceleration of the mobile object 110, and when the absolute value of vertical acceleration is greater than the measuring threshold of the accelerometer, determines that the road surface is uneven.

In the description hereinafter, description will be given taking a vehicle such as an automobile, a motorcycle, a bicycle, and the like as one example of the mobile object 110. Further, in the description hereinafter, the mobile object 110 may be indicated as “vehicle 110”, and the motion data of the mobile object 110 may be indicated as “travel data of the vehicle 110”.

When the vehicle 110 is traveling in an urban area, there are sections where the speed of the vehicle 110 has to be reduced or the vehicle 110 has to be stopped consequent to other vehicles 110 or traffic signals. Further, there are sections where the vehicle 110 turns left or right such as at intersections, 3-way intersections, curves, and the like. Therefore, the travel status of the vehicle 110 transitions through various states such as the stopped state, the accelerating state, the decelerating state, the constant speed state, the turning right state, the turning left state, and the straight traveling state during travel.

Here, even when the state of the road surface unevenness is the same, if the travel status of the vehicle 110 differs, the measured value obtained by the accelerometer equipped on the vehicle 110 may differ. Therefore, if road surface unevenness is detected using the same measuring threshold without taking the travel status of the vehicle 110 into consideration, the accuracy of unevenness detection may decrease.

For example, when the vehicle 110 is accelerating or decelerating, excessive vertical movement occurs consequent to the suspension sinking and therefore, the measured value for vertical acceleration of the vehicle 110 tends to be greater than when the vehicle 110 is traveling at a constant speed. More specifically, for example, when the vehicle 110 is traveling 30 km/h on a road and is accelerating having transitioned from the stopped state to the accelerating state, the vertical acceleration tends to be greater than the vertical acceleration when the vehicle 110 is traveling at a constant speed of 30 km/h on the same road. Therefore, for example, if the vehicle 110 is assumed to be traveling at a constant speed of 30 km/h and the measuring threshold of the accelerometer is defined, road surface unevenness may be errantly detected when the vehicle 110 is accelerating and traveling at 30 km/h on a flat road.

Thus, in the first embodiment, the unevenness analyzer 100 executes unevenness detection by reducing the sensitivity of road surface unevenness detection when the traveling vehicle 110 is in the accelerating or decelerating state to be lower than that when the vehicle 110 is in a constant speed, straight traveling state. As a result, the unevenness analyzer 100 can analyze road surface unevenness with high accuracy by taking into consideration the effects of increasing acceleration with respect to the travel status of the vehicle 110.

Further, for example, when the vehicle 110 is turning left or right, excessive vertical movement occurs consequent to the suspension sinking and therefore, the measured value for vertical acceleration of the vehicle 110 tends to be greater than when the vehicle 110 is traveling at a constant speed. More specifically, for example, when the vehicle 110 is turning right on a curved road and traveling at a constant speed of 30 km/h, the vertical acceleration tends to be greater than the vertical acceleration when the vehicle is traveling at a constant speed of 30 km/h on a straight road. Therefore, for example, if the vehicle 110 is assumed to be traveling at a constant speed of 30 km/h and the measuring threshold of the accelerometer is defined, road surface unevenness may be errantly detected when the vehicle 110 is turning right at a speed of 30 km/h on a road.

Thus, in the first embodiment, the unevenness analyzer 100 executes unevenness detection by reducing the sensitivity of road surface unevenness detection when the vehicle 110 is in the turning right state or the turning left state to be lower than that when the vehicle 110 is in the constant speed, straight traveling state. As a result, the unevenness analyzer 100 can analyze road surface unevenness with high accuracy by taking into consideration the effects of increasing acceleration with respect to the travel status of the vehicle 110.

Road surface unevenness exists in various forms and at various locations. Therefore, when the vehicle 110 is traveling in an urban area or the like, wheels on both sides, or wheels on one side of the vehicle 110 pass over unevenness in a road surface. For example, when road surface unevenness is a manhole cover, wheels on one side of the vehicle 110 pass over the unevenness.

Here, if the shape or position of road surface unevenness differs, the measured value obtained by the accelerometer equipped on the vehicle 110 may differ. For example, when unevenness is present only on the left side of a road surface, movement is less than when both sides of a road surface are uneven and therefore, the measured value of vertical acceleration for the vehicle 110 tends to be lower. More specifically, when the vehicle 110 is traveling at a constant speed of 30 km/h on a road surface that is uneven on the left side only, the vertical acceleration tends to be lower than when the vehicle 110 is traveling at a constant speed of 30 km/h on a road surface that is uneven on both sides. Therefore, for example, if the vehicle 110 is assumed to be traveling on a road surface that is uneven on both sides, road surface unevenness may not be detected when the vehicle 110 is traveling on a road surface that is uneven only on the left side.

Thus, in the first embodiment, with respect to measuring points at which composite acceleration, which is a combination of longitudinal, lateral, and vertical acceleration, is a predetermined value or greater, the unevenness analyzer 100 executes unevenness detection by increasing the sensitivity of road surface unevenness detection to be greater than that for a constant speed, straight traveling state. As a result, the unevenness analyzer 100 can analyze road surface unevenness with high accuracy by taking the road surface state into consideration. Hereinafter, an example of an unevenness analysis process of the unevenness analyzer 100 will be described.

(1) The unevenness analyzer 100 obtains travel data of the vehicle 110 that has traveled from point A to point B on a road as depicted in a top view. The travel data of the vehicle 110, for example, is information that includes the acceleration of the vehicle 110 measured at a constant period or at a constant distance by the accelerometer equipped on the vehicle 110.

In the example depicted in FIG. 1, the unevenness analyzer 100 obtains travel data that includes the acceleration of the vehicle 110 measured at measuring points P1 to Pn. The accelerometer may be provided in the unevenness analyzer 100 or may be provided on the vehicle 110.

(2) The unevenness analyzer 100 separates the obtained travel data of the vehicle 110 according to section. Subsequently, based on the travel status of the vehicle 110 indicated by the travel data for each section, the unevenness analyzer 100 identifies travel data within a predetermined distance or travel data within a predetermined period from a stopped state of the vehicle 110. In other words, the unevenness analyzer 100 identifies travel data corresponding to acceleration of the vehicle 110.

Here, travel data within a predetermined period (or within a predetermined distance) from a stopped state of the vehicle 110, for example, is travel data measured during a period when (or, within a distance where) the travel status of the vehicle 110 transitions from a stopped state to an accelerating state, and transitions from the accelerating state to a constant speed state. Further, travel data within a predetermined period (or, a predetermined distance) from a stopped state of the vehicle 110 may be travel data measured during a predetermined period (or predetermined distance) from the stopped state when the travel status of the vehicle 110 transitions from a stopped state to an accelerating state. The predetermined period (or predetermined distance) in this case can be set arbitrarily and, for example, a value of several seconds (or, several meters) is set.

The unevenness analyzer 100 further identifies travel data within a predetermined distance or travel data within a predetermined period until a stopped state of the vehicle 110, based on the travel status of the vehicle 110 indicated by the travel data of the vehicle 110 for each section. In other words, the unevenness analyzer 100 identifies travel data corresponding to deceleration of the vehicle 110.

Here, travel data within a predetermined period (or, predetermined distance) until a stopped state of the vehicle 110 is travel data measured during a period when (or, within a distance where) the travel status of the vehicle 110 transitions from a constant speed state to a decelerating state, and transitions from the decelerating state to a stopped state. Further, travel data within a predetermined period (or, predetermined distance) until a stopped state of the vehicle 110 may be travel data measured during a predetermined period (or, predetermined distance) until the stopped state when the travel status of the vehicle 110 transitions from a decelerating state to a stopped state. In this case, the predetermined period (or, the predetermined distance) is set arbitrarily and, for example, a value of several seconds (or, several meters) is set.

The unevenness analyzer 100 identifies travel data within a predetermined distance or travel data within a predetermined period from a turning right state or a turning left state of the vehicle 110, based on the travel status of the vehicle 110 indicated by the travel data of the vehicle 110 for each section. In other words, the unevenness analyzer 100 identifies travel data corresponding to turning right or turning left by the vehicle 110.

Here, travel data within a predetermined period (or, predetermined distance) from a turning right state of the vehicle 110, for example, is travel data measured during a period when (or, within a distance where) the travel status of the vehicle 110 transitions from a straight traveling state to a turning right state, and transitions from the turning right state to a straight traveling state. Further, travel data within a predetermined period (or, a predetermined distance) from a turning left state of the vehicle 110 is travel data measured during a period (distance) when the travel status of the vehicle 110 transitions from a straight traveling state to a turning left state, and transitions from the turning left state to a straight traveling state.

In the example depicted in FIG. 1, the travel status of the vehicle 110 changes between a stopped state, an accelerating, a straight traveling state, a turning left state, a turning right state, a constant speed, a straight traveling state, a decelerating, a straight traveling state, and a stopped state. More specifically, point P1 is a stopped state; from point P1 to point P3 is an accelerating, straight traveling state; from point P4 to point P6 is a turning left state; from point P7 to point P9 is a turning right state; from point P10 to point P12 is a constant speed, straight traveling state; from point P(n−1) to point Pn is a decelerating, straight traveling state; and point Pn is a stopped state.

In this case, the unevenness analyzer 100 identifies travel data that includes acceleration from point P1 to point P3, and from point P(n−1) to point Pn as travel data within a predetermined distance or travel data within a predetermined period from a stopped state of the vehicle 110. Further, the unevenness analyzer 100 identifies travel data that includes acceleration from point P4 to point P6, and from point P7 to point P9 as travel data within a predetermined distance or travel data within a predetermined period from a turning right state or a turning left state of the vehicle 110. The unevenness analyzer 100 further identifies travel data that includes acceleration at point P12 as travel data corresponding to travel on an uneven road surface.

(3) The unevenness analyzer 100 makes comparison concerning travel data identified as travel data within a predetermined distance or travel data within a predetermined period from a stopped state of the vehicle 110 and travel data not belonging to the identified travel data and executes detection of road surface unevenness by a reduced sensitivity. As a result, the unevenness analyzer 100 makes comparison concerning the identified travel data and travel data not belonging to the identified travel data and executes detection of road surface unevenness by a reduced sensitivity, even when the travel data of the vehicle 110 indicates movement at the same speed. Here, detection of road surface unevenness is a process of comparing vertical acceleration of the vehicle 110 and the measuring threshold of the accelerometer, and determining that unevenness is present in a road surface when the absolute value of the vertical acceleration is greater than the measuring threshold of the accelerometer.

Further, a lowering of the sensitivity of road surface unevenness detection is making a condition for the unevenness analyzer 100 to determine that unevenness of a road surface stricter. For example, concerning travel data belonging to the identified travel data, the unevenness analyzer 100 may increase the measuring threshold of the accelerometer and compare the increased measuring threshold and the vertical acceleration to thereby, execute detection of road surface unevenness.

Further, the unevenness analyzer 100 may set travel data belonging to the identified travel data to be excluded from road surface unevenness detection. The unevenness analyzer 100 may make the absolute value of the vertical acceleration of the identified travel data smaller and compare the absolute value of the vertical acceleration for which the absolute value has been made smaller and the measuring threshold of the accelerometer to thereby, execute detection of road surface unevenness.

The unevenness analyzer 100 makes comparison concerning travel data identified as travel data within a predetermined distance or travel data within a predetermined period from a turning right state or a turning left state of the vehicle 110 and travel data not belonging to the identified travel data, and executes detection of road surface unevenness by a reduced sensitivity. As a result, the unevenness analyzer 100 makes comparison concerning the identified travel data and travel data not belonging to the identified travel data, and executes detection of road surface unevenness, when travel data of the vehicle 110 indicates movement at the same speed.

Subsequently, with respect to measuring points at which composite acceleration, which is a combination of the longitudinal, lateral, and vertical acceleration, is a predetermined value or greater, the unevenness analyzer 100 executes detection of road surface unevenness by a higher sensitivity, even when the travel data of the vehicle 110 is less than the measuring threshold of the accelerometer.

As described, according to the unevenness analyzer 100 of the first embodiment, unevenness detection can be executed by a sensitivity that has been set to be lower than for other travel data and that is based on travel data within a predetermined distance or travel data within a predetermined period from a stopped state of the vehicle 110.

For example, according to the unevenness analyzer 100, when the vehicle 110 is in an accelerating state, or a decelerating state, unevenness detection can be executed with the sensitivity of road surface unevenness detection being set lower than for other states. As a result, the unevenness analyzer 100 can analyze road surface unevenness with a high accuracy by taking into consideration the effects of the travel status of the vehicle 110 on the detection of road surface unevenness.

Further, for example, according to the unevenness analyzer 100 of the first embodiment, unevenness detection can be executed with the sensitivity of road surface unevenness detection when the vehicle 110 is in a turning right state, or a turning left state being set lower than for other states. As a result, the unevenness analyzer 100 can analyze road surface unevenness with high accuracy by taking into consideration the effects of the travel status of the vehicle 110 on the detection of road surface unevenness.

Further, for example, according to the unevenness analyzer 100 of the first embodiment, concerning measuring points at which the composite acceleration, which is a combination of the longitudinal, lateral, and vertical acceleration, is a predetermined value or greater, unevenness detection can be executed with the sensitivity of road surface unevenness detection being set higher than that for a constant speed, straight traveling state. As a result, the unevenness analyzer 100 can analyze road surface unevenness with high accuracy by taking into consideration the effects of the shape and position of the road surface unevenness on the detection of the road surface unevenness.

Here, although a case has been described where the unevenness analyzer 100 analyzes road surface unevenness based on longitudinal, lateral, and vertical acceleration, configuration is not limited hereto. For example, in place of acceleration, the unevenness analyzer 100 may analyze road surface unevenness based on the amplitude of generated vibrations in longitudinal, lateral, and vertical directions. The unevenness analyzer 100, for example, may detect the amplitude of generated vibrations in longitudinal, lateral, and vertical directions using vibration sensors.

Although a case has been described where the unevenness analyzer 100 identifies as travel data corresponding to acceleration of the vehicle 110, travel data within a predetermined distance or travel data with in a predetermined period from a stopped state of the vehicle 110, configuration is not limited hereto. For example, the unevenness analyzer 100 may identify as travel data corresponding to acceleration of the vehicle 110, travel data for which forward acceleration is continuously a predetermined value or greater.

Similarly, although a case has been described where the unevenness analyzer 100 identifies as travel data corresponding to deceleration of the vehicle 110, travel data that is within a predetermined distance or travel data that is within a predetermined period until a stopped state of the vehicle 110, configuration is not limited hereto. For example, the unevenness analyzer 100 may identify as travel data corresponding to deceleration of the vehicle 110, travel data for which backward acceleration is continuously a predetermined value or greater.

Similarly, although a case has been described where the unevenness analyzer 100 identifies as travel data corresponding to turning left or turning right by the vehicle 110, travel data within a predetermined distance or travel data within a predetermined period from a turning right state or a turning left state of the vehicle 110, configuration is not limited hereto. For example, the unevenness analyzer 100 may identify as travel data corresponding to turning left or turning right by the vehicle 110, travel data for which lateral acceleration is continuously a predetermined value or greater.

An example of system configuration of a system 200 according to a second embodiment will be described. Portions identical to those described in the first embodiment are given the same reference numerals used in the first embodiment and description thereof is omitted hereinafter.

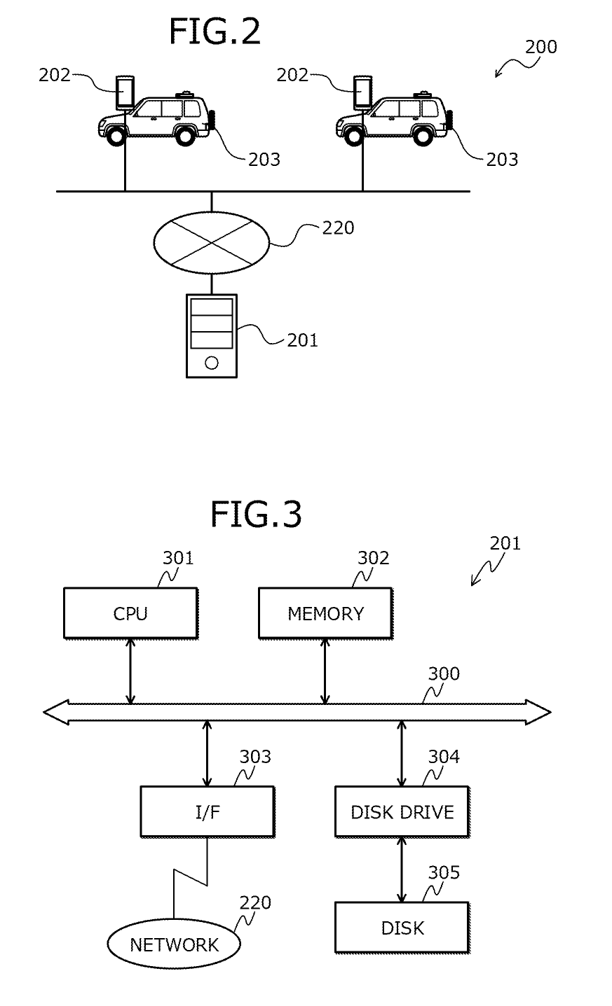

FIG. 2 is a diagram depicting an example of system configuration of the system 200. In FIG. 2, the system 200 includes an unevenness analyzer 201, a travel data measuring device 202 (2 devices in the example depicted in FIG. 2), and a vehicle 203 (2 vehicles in the example depicted in FIG. 2).

In the system 200, the unevenness analyzer 201 and the travel data measuring devices 202 are connected through a wired or a wireless network 220. The network 220, for example, is a local area network (LAN), a wide area network (WAN), the Internet, and the like.

The unevenness analyzer 201 is a computer that analyzes unevenness of a road surface traveled by the vehicles 203. More specifically, for example, the unevenness analyzer 201 is a server, a personal computer (PC), and the like.

The travel data measuring device 202 is a computer that measures travel data of the vehicle 203. More specifically, for example, the travel data measuring device 202 may be a communications device such as a smartphone, a mobile telephone, a tablet PC, and the like, and further may be a vehicle-equipped device such as a car navigation device equipped on the vehicle 203.

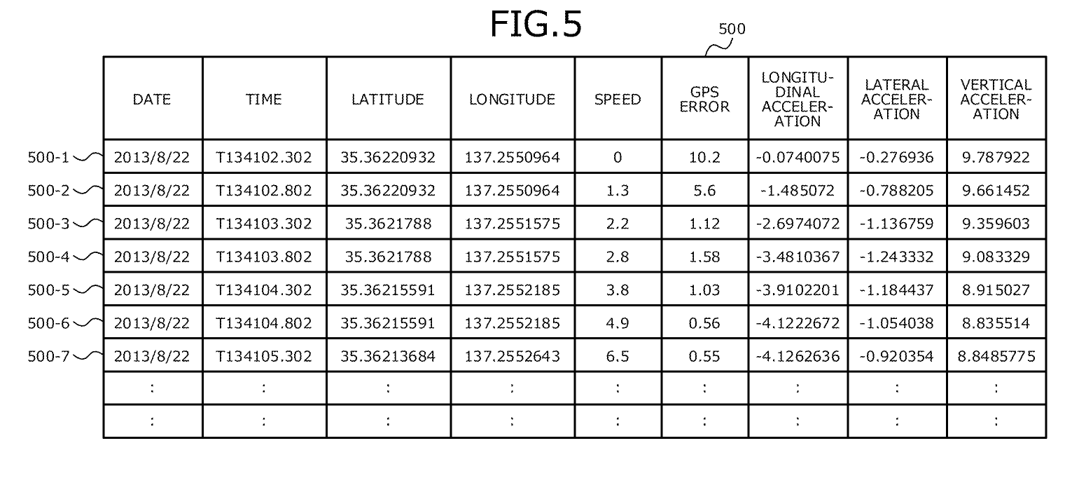

The vehicle 203 is an automobile, a motorcycle, a bicycle, and the like. Travel data of the vehicle 203 will be described in detail with reference to FIG. 5. The unevenness analyzer 201 and the travel data measuring devices 202 correspond to the unevenness analyzer 100 depicted in FIG. 1 and the vehicles 203 correspond to the mobile object 110 (the vehicle 110) depicted in FIG. 1.

Herein, although the unevenness analyzer 201 and the travel data measuring device 202 are described to be independent devices, configuration is not limited hereto. For example, the travel data measuring device 202 may have a function as the unevenness analyzer 201.

FIG. 3 is a block diagram of an example of hardware configuration of the unevenness analyzer 201. In FIG. 3, the unevenness analyzer 201 has a central processing unit (CPU) 301, memory 302, an interface (I/F) 03, a disk drive 304, and a disk 305, respectively connected by a bus 300.

Here, the CPU 301 governs overall control of the unevenness analyzer 201. The memory 302, for example, includes read-only memory (ROM), random access memory (RAM), and flash ROM.

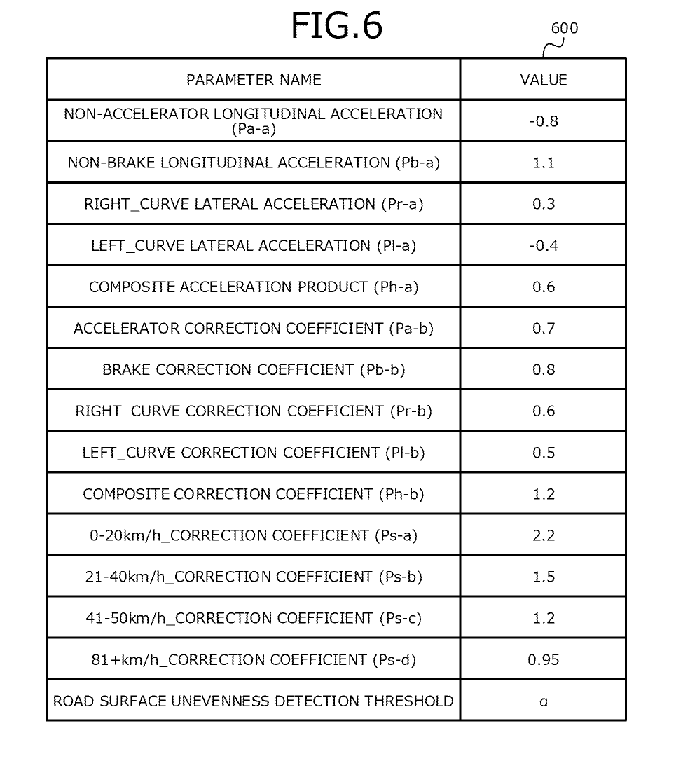

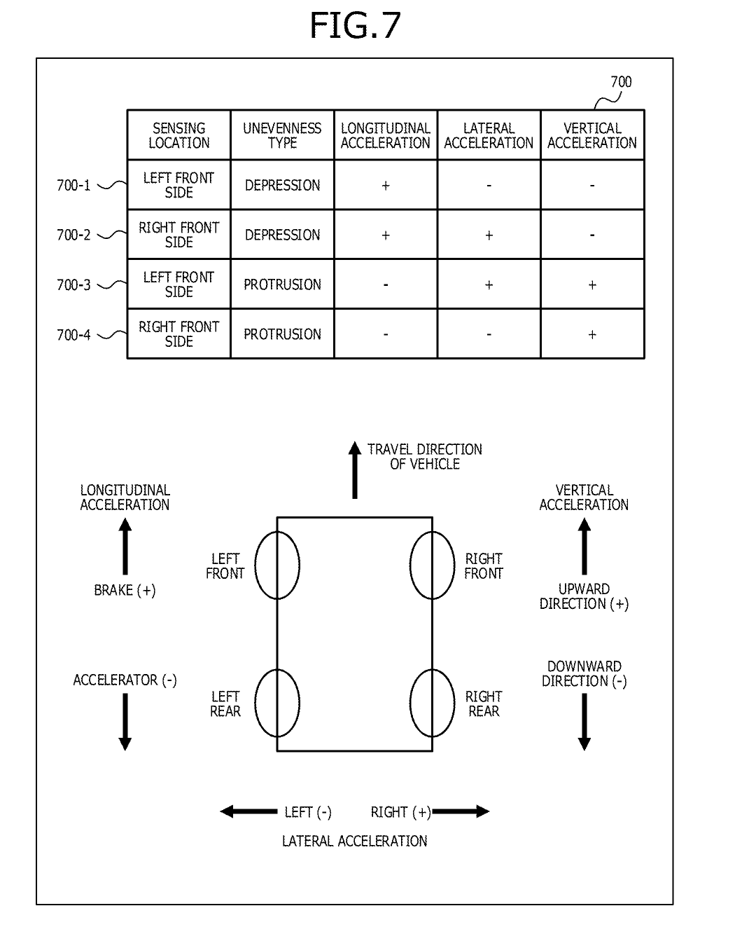

More specifically, for example, the flash ROM and the ROM store various programs such as a boot program and an unevenness analysis program according to the present embodiment; and the RAM is used as work area of the CPU 301. Programs stored in the memory 302 are loaded onto the CPU 301, whereby the CPU 301 executes encoded processes. Further, for example, the flash ROM and ROM store various tables such as travel data 500 described hereinafter with reference to FIG. 5, an analysis parameter 600 described hereinafter with reference to FIG. 6, and an unevenness analysis table 700 described hereinafter with reference to FIG. 7.

The I/F 303 is connected to the network 220 through a communications line and is connected to other computers (for example, the travel data measuring device 202 depicted in FIG. 2) via the network 220. The I/F 303 administers an internal interface with the network 220 and controls the input and output of data from other computers. The I/F 303, for example, may be a modem, a LAN adapter, and the like.

The disk drive 304 is a control device that under the control of the CPU 301, controls the reading and writing of data with respect to the disk 305. The disk drive 304, for example, may be a magnetic disk drive and the like. The disk 305 is non-volatile memory that stores therein data written thereto under the control of the disk drive 304. For example, when the disk drive 304 is a magnetic disk drive, the disk 305 may be a magnetic disk.

In addition to the configuration above, the unevenness analyzer 201 may further have, for example, a solid state drive (SSD), a keyboard, a mouse, a printer, a display, and the like. Further, the unevenness analyzer 201 may have a SSD and the like in place of the disk drive 304 and the disk 305.

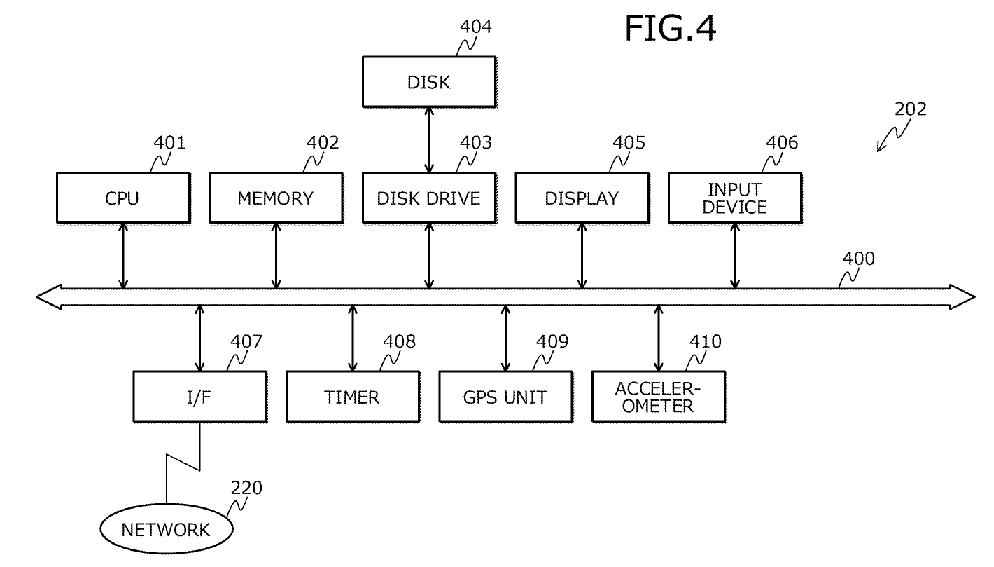

FIG. 4 is a block diagram of an example of hardware configuration of the travel data measuring device 202. In FIG. 4, the travel data measuring device 202 has a CPU 401, memory 402, a disk drive 403, and a disk 404. Further, the travel data measuring device 202 has a display 405, an input device 406, an I/F 407, a timer 408, a global positioning system (GPS) unit 409, and an accelerometer 410. The respective components are connected by a bus 400.

Here, the CPU 401 governs overall control of the travel data measuring device 202. The memory 402, for example, includes ROM, RAM, and flash ROM. More specifically, for example, the flash ROM and ROM store various types of programs such as a boot program; and the RAM is used as a work area of the CPU 401. Programs stored in the memory 402 are loaded onto the CPU 401 whereby, the CPU 401 executes encoded processes.

The disk drive 403 is a control device that under the control of the CPU 401, controls the reading and writing of data with respect to the disk 404. The disk drive 403 may be, for example, a magnetic disk drive and the like. The disk 404 is non-volatile memory that stores therein data written thereto under the control of the disk drive 403. For example, when the disk drive 403 is a magnetic disk drive, the disk 404 may be a magnetic disk.

The display 405 displays data such as documents, images, and functional information in addition to a cursor, icons, and toolboxes. The display 405, for example, may be a CRT, a TFT liquid display, a plasma display, and the like. The input device 406 has keys for imputing text, numerals, instructions, and the like; and performs data input. The input device 406 may be a touch panel input pad, a numeric pad, and the like.

The I/F 407 is connected to the network 220 through a communications line and is connected to other devices (for example, the unevenness analyzer 201 depicted in FIG. 2) via the network 220. The I/F 407 administers an internal interface with the network 220, and controls the input and output of data from external devices.

The GPS unit 409 receives radio waves (GPS signals) from GPS satellites, and outputs position information indicating the position of the travel data measuring device 202 (the vehicle 203). The position information of the travel data measuring device 202 (the vehicle 203), for example, is information specifying one point on earth by latitude, longitude, altitude, etc.

The accelerometer 410 outputs tri-axial (longitudinal, lateral, and vertical) acceleration of the travel data measuring device 202. The accelerometer 410, for example, detects longitudinal acceleration as a negative value when force in a backward direction is applied to the mobile object and as a positive value when force in a forward direction is applied to the mobile object. Further, the accelerometer 410 detects vertical acceleration as a positive value when the mobile object is moving in an upward direction and as a negative value when the mobile object is moving in a downward direction. With respect to lateral acceleration, the accelerometer 410 detects acceleration as a positive value when the mobile object is moving in a rightward direction and as a negative value when the mobile object is moving in a leftward direction. The corresponding relations of the positive and negative values and the direction of the acceleration detected by the accelerometer 410 may differ from the examples given above.

The above configuration of the travel data measuring device 202, for example, may omit the timer 408, the GPS unit 409, and the accelerometer 410. In this case, the travel data measuring device 202, for example, may obtain from a sensor equipped on the vehicle 203, the acceleration of the vehicle 203, the time, position, etc. Further, in addition to the configuration above, the travel data measuring device 202 may further have a SSD and the like. The travel data measuring device 202 may further have a SSD and the like in place of the disk drive 403 and the disk 404.

FIG. 5 is a diagram depicting one example of the contents of the travel data 500. In FIG. 5, the travel data 500 has fields for dates, times, latitudes, longitudes, speeds, GPS error, longitudinal acceleration, lateral acceleration, and vertical acceleration.

The travel data 500 stores travel data information (for example, travel data information 500-1 to 500-7) as records consequent to information being set into the fields for respective time points during travel of the vehicle 203. In the example depicted in FIG. 5, although the travel data information is measured at 0.5-second intervals, the travel data information may be measured at constant distance intervals.

Here, the date and the time are information that indicates the date and time that the information of the record was obtained. The date and time are measured by the timer 408 of the travel data measuring device 202. The longitude and the latitude are information indicating the position of the vehicle 203 and are measured from GPS radio waves received by the GPS unit 409 of the travel data measuring device 202.

The speed is information that indicates the speed of the vehicle 203 at the time indicated in the record. The unit of the speed is km/h. Here, the travel data measuring device 202 need not directly measure the speed. For example, the travel data measuring device 202 can calculate the speed from the time, the longitude, and the latitude. The travel data measuring device 202, more specifically, for example, calculates the distance traveled by the vehicle 203, from the longitude and latitude of the travel data information 500-1 and the longitude and latitude of the travel data information 500-2. Further, the travel data measuring device 202 divides the calculated distance by the difference of the time of the travel data information 500-2 and the time of the travel data information 500-1 and thereby, calculates the speed.

The GPS error is error indicating the extent to which the latitude and longitude position information by the GPS signal may deviate. The longitudinal acceleration is information indicating longitudinal acceleration of the vehicle 203 at the time of the record. The lateral acceleration is information indicating lateral acceleration of the vehicle 203 at the time of the record. The vertical acceleration is information indicating vertical acceleration of the vehicle 203 at the time of the record. The unit of the longitudinal, lateral, and vertical acceleration, for example, is m/ŝ2.

Longitudinal acceleration takes a negative value when the mobile object accelerating since a backward force is applied to the accelerometer 410; and takes a positive value when the mobile object is decelerating. Vertical acceleration takes a positive value when the mobile object is moving upward and takes negative value when the mobile object is moving downward. Further, lateral acceleration takes a positive value when the mobile is moving rightward and takes a negative value when the mobile object is moving leftward. Depending on the installation of the travel data measuring device 202 with respect to the mobile object, corresponding relations of the positive and negative values and the direction of acceleration of the mobile object acceleration may differ from the example described above.

The travel data 500 depicted in FIG. 5 corresponds to the travel data of the vehicle 110 depicted in FIG. 1. The travel data 500, for example, is stored to the disk 404 depicted in FIG. 4.

FIG. 6 is a diagram depicting one example of the contents of the analysis parameter 600. The analysis parameter 600 has values of non-accelerator longitudinal acceleration Pa-a, non-brake longitudinal acceleration Pb-a, right_curve lateral acceleration Pr-a, left_curve lateral acceleration Pl-a, and composite acceleration product Ph-at.

The analysis parameter 600 further has values of an accelerator correction coefficient Pa-b, a brake correction coefficient Pb-b, a right_curve correction coefficient Pr-b, a left_curve correction coefficient Pl-b, and a composite correction coefficient Ph-b.

The analysis parameter 600 has values of a 0-20 km/h_correction coefficient Ps-a, a 21-40 km/h_correction coefficient Ps-b, a 41-50 km/h_correction coefficient Ps-c, 81+km/h_correction coefficient Ps-d, and a road surface unevenness detection threshold. The analysis parameter 600, for example, is stored to the memory 302 or the disk 305 depicted in FIG. 3.

Here, the non-accelerator longitudinal acceleration Pa-a is a first threshold used for determining whether a measured section is an accelerator section. A measured section is a section that has multiple measuring points. The unevenness analyzer 201 identifies the travel status of the vehicle 203 for each measured section.

Travel status of the vehicle 203 is a traveling state of the vehicle 203 during the measured section. Traveling states, for example, include a stopped section, an accelerator section, a brake section, a right_curve section, a left_curve section, a constant speed section, and the like. The travel status of the vehicle 203 corresponds to the motion status of the mobile object 110 of the first embodiment.

A stopped section is a section where the vehicle 203 is stopped, i.e., a section where the speed is 0. An accelerator section is a section where the vehicle 203 enters an accelerating state by the accelerator. A brake section is a section where the vehicle 203 enters a decelerating state by the brake. A right_curve section is a section where rightward acceleration of the mobile object 110 is a predetermined value or greater. A left_curve section is a section where leftward acceleration of the mobile object 110 is a predetermined value or greater. A constant speed section is a section where the vehicle 203 is traveling at a substantially constant speed.

The non-brake longitudinal acceleration Pb-a is a second threshold used for determining whether the measured section is a brake section. The right_curve lateral acceleration Pr-a is a third threshold used for determining whether the measured section is a right_curve section. The left_curve lateral acceleration Pl-a is a fourth threshold used for determining whether the measured section is a left_curve section.

The accelerator correction coefficient Pa-b is a correction coefficient for vertical acceleration in an accelerator section. The brake correction coefficient Pb-b is a correction coefficient for vertical acceleration in a brake section. The right_curve correction coefficient Pr-b is a correction coefficient for vertical acceleration in a right_curve section. The left_curve correction coefficient Pl-b is a correction coefficient for vertical acceleration in a left_curve section.

The 0-20 km/h_correction coefficient Ps-a is a correction coefficient for vertical acceleration in a measured section where the vehicle 203 is in a constant speed state of 0-20 km/h. The 21-40 km/h_correction coefficient Ps-b, the 41-50 km/h_correction coefficient Ps-c, and the 81+km/h_correction coefficient Ps-d are similar correction coefficients. Between 51-80 km/h correction is not performed and therefore, no corresponding correction coefficient exists.

The road surface unevenness detection threshold is a threshold for determining road surface unevenness. The unevenness analyzer 201 detects road surface unevenness by comparing the road surface unevenness detection threshold and vertical acceleration. For example, the unevenness analyzer 201 determines that unevenness is present in a road surface, when the absolute value of vertical acceleration is greater than the road surface unevenness detection threshold. The road surface unevenness detection threshold corresponds to the measuring threshold of the accelerometer of the first embodiment.

FIG. 7 is a diagram depicting one example of the contents of the unevenness analysis table 700. As depicted in FIG. 7, the unevenness analysis table 700 has fields for sensing locations, unevenness types, “longitudinal acceleration”, “lateral acceleration”, and “vertical acceleration”. The unevenness analysis table 700 stores unevenness analysis information (for example, unevenness analysis information 700-1 to 700-4) as records consequent to information being set into the fields according to road surface state. The unevenness analysis table 700, for example, is stored to the memory 302 or the disk 305 depicted in FIG. 3.

Here, a sensing location is information that indicates for the road surface state, whether the right and/or left side of the vehicle 203 passed over road surface unevenness. Unevenness type is information that indicates for the road surface state, whether the road surface unevenness is a depression or a protrusion.

“Longitudinal acceleration” is information indicating the sign of longitudinal acceleration of the vehicle 203 when the vehicle 203 passed unevenness in the road surface state. “Lateral acceleration” is information indicating the sign of lateral acceleration of the vehicle 203 when the vehicle 203 passed unevenness in the road surface state. “Vertical acceleration” is information indicating the sign of vertical acceleration of the vehicle 203 when the vehicle 110 passed unevenness in the road surface state.

As depicted in FIG. 7, when the mobile object accelerates, longitudinal acceleration takes a negative value since a force in the backward direction is applied to the accelerometer 410; and when the mobile object decelerates, longitudinal acceleration takes a positive value. Further, when the mobile object moves in an upward direction, vertical acceleration takes a positive value; and when the mobile moves in a downward direction, vertical acceleration takes a negative value. When the mobile object moves in a rightward direction, lateral acceleration takes a positive value, and when the mobile object moves in a leftward direction, lateral acceleration takes a negative value.

More specifically, for example, the unevenness analysis information 700-1 is information indicating that longitudinal acceleration is a positive value; lateral acceleration is a negative value; and vertical acceleration is a negative value when the left front wheel of the vehicle 203 passes a depression since the left front wheel of the vehicle 203 sinks.

In the description hereinafter, a pattern that combines the positive and negative signs of the longitudinal, lateral, and vertical acceleration indicated by the unevenness analysis information 700-1 may be indicated as “left side depression pattern”. Further, a pattern that combines the positive and negative signs of the longitudinal, lateral, and vertical acceleration, indicated by the unevenness analysis information 700-2 may be indicated as “right side depression pattern”.

A pattern that combines the positive and negative signs of the longitudinal, lateral, and vertical acceleration, indicated by the unevenness analysis information 700-3 may be indicated as “left side protrusion pattern”. A pattern that combines the positive and negative signs of the longitudinal, lateral, and vertical acceleration, indicated by the unevenness analysis information 700-4 may be indicated as “right side protrusion pattern”.

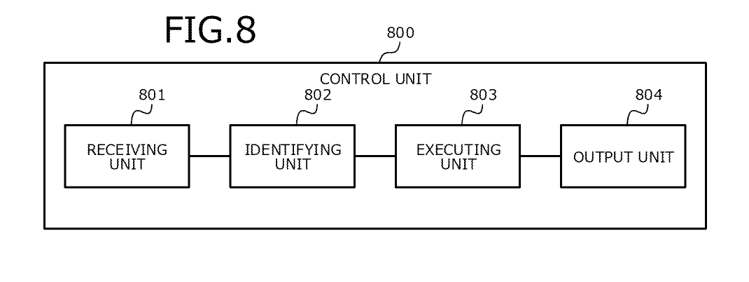

An example of a functional configuration of the unevenness analyzer 201 will be described with reference to FIG. 8.

FIG. 8 is a block diagram of an example of a functional configuration of the unevenness analyzer 201. The unevenness analyzer 201 includes as a control unit 800, a receiving unit 801, an identifying unit 802, an executing unit 803, and an output unit 804. The functions, more specifically, for example, are implemented by executing on the CPU 301, a program stored in a storage apparatus such as the memory 302 and the disk 305 depicted in FIG. 3, or by the I/F 303. Process results of the functional units, for example, are stored to a storage apparatus such as the memory 302 and the disk 305 depicted in FIG. 3.

Here, for example, when the measured section is an accelerator section, the unevenness analyzer 201 sets the sensitivity of the unevenness detection to be lower than in a case of operations corresponding to a constant speed section, and performs operations of detecting road surface unevenness of the measured section from the travel data 500. In the description hereinafter, operations of detecting road surface unevenness of the measured section when the measured section is an accelerator section may be indicated as “operations corresponding to an accelerator section”.

Further, for example, when the measured section is a brake section, the unevenness analyzer 201 sets the sensitivity of the unevenness detection to be lower than in a case of operations corresponding to a constant speed section, and performs operations of detecting road surface unevenness of the measured section from the travel data 500. In the description hereinafter, operations of detecting road surface unevenness of the measured section when the measured section is a brake section may be indicated as “operations corresponding to a brake section”.

Further, for example, when the measured section is a right_curve section, the unevenness analyzer 201 sets the sensitivity of the unevenness detection to be lower than in a case of operations corresponding to a constant speed section, and performs operations of detecting road surface unevenness of the measured section from the travel data 500. In the description hereinafter, operations of detecting road surface unevenness of the measured section when the measured section is a right_curve section may be indicated as “operations corresponding to a right_curve section”

Further, for example, when the measured section is a left_curve section, the unevenness analyzer 201 sets the sensitivity of the unevenness detection to be lower than in a case of operations corresponding to a constant speed section, and performs operations of detecting road surface unevenness of the measured section from the travel data 500. In the description hereinafter, operations of detecting road surface unevenness of the measured section when the measured section is a left_curve section may be indicated as “operations corresponding to a left_curve section”.

As described above, for each section in which the travel data 500 is measured, the unevenness analyzer 201 can perform operations corresponding to the type of measured section. For example, when the measured section is a constant speed section, the unevenness analyzer 201 performs operations of detecting road surface unevenness of the measured section from the travel data 500. In the description hereinafter, operations of detecting road surface unevenness of the measured section when the measured section is a constant speed section may be indicated as “operations corresponding to a constant speed section”.

Further, as described above, the unevenness analyzer 201 can perform operations of determining road surface unevenness for each section in which the travel data 500 is measured, based on composite acceleration, which is a combination of the longitudinal, lateral, and vertical acceleration. In the description hereinafter, operations of determining road surface unevenness based on composite acceleration may be indicated as “operations corresponding to composite acceleration”.

In the description hereinafter, operations corresponding to an accelerator section, operations corresponding to a brake section, operations corresponding to a right_curve section, operations corresponding to a left_curve section, operations corresponding to a constant speed section, and operations corresponding to composite acceleration will be described.

Operations corresponding to an accelerator section will be described. Operations corresponding to an accelerator section are operations of setting the sensitivity of the unevenness detection to be lower than in a case of operations corresponding to a constant speed section, and detecting road surface unevenness of the measured section from the travel data 500.

The receiving unit 801 receives mobile object motion data that includes at least longitudinal acceleration of the mobile object. Here, the mobile object 110, as described above, is an object capable of powered motion on a road surface by, for example, an internal combustion engine, a battery, and human power. The mobile object 110 is, for example, the vehicle 203 depicted in FIG. 2. The mobile object motion data, described above, is data that indicates the motion status of the mobile object 110. The mobile object motion data, for example, is the travel data 500 depicted in FIG. 5.

The receiving unit 801, for example, receives the travel data 500 from the travel data measuring device 202. The receiving unit 801, more specifically, for example, receives the travel data 500 when the unevenness analyzer 201 executes detection of road surface unevenness after the travel data measuring device 202 finishes obtaining the travel data 500 for the road surface.

When the unevenness analyzer 201 and the travel data measuring device 202 are connected by the network 220 which is wired, the receiving unit 801 may receive the travel data 500 from the travel data measuring device 202 in real-time. Thus, the receiving unit 801 can obtain the travel data 500 for detecting road surface unevenness.

The identifying unit 802 identifies motion data indicating an accelerating state of the mobile object, based on the motion status of the mobile object indicated by the mobile object motion data that includes at least longitudinal acceleration of the mobile object. The identifying unit 802, for example, identifies motion data that indicates an accelerating state of the vehicle 203, based on the travel status of the vehicle 203 indicated by the travel data 500 of the vehicle 203.

The identifying unit 802, more specifically, for example, separates the travel data 500 received by the receiving unit 801 into measured sections, and for each measured section, determines whether the measured section is an accelerator section and thereby, identifies the travel status of the vehicle 203. The identifying unit 802 identifies among the travel data 500, travel data that indicates an accelerating state of the vehicle 203.

The identifying unit 802, more specifically, for example, based on a temporal change in the longitudinal acceleration included in the travel data for a first measured section, among the travel data 500, determines whether the first measured section is an accelerator section. Here, the identifying unit 802 determines that the first measured section is an accelerator section, when each longitudinal acceleration included in the travel data 500 for the first measured section is the non-accelerator longitudinal acceleration Pa-a or less. The identifying unit 802, when determining that the first measured section is an accelerator section, identifies among the travel data 500, the travel data for the first measured section to be travel data indicating an accelerating state of the vehicle 203.

Thus, the executing unit 803 can perform detection of road surface unevenness at a sensitivity that corresponds to the traveling state identified by the identifying unit 802. In the description hereinafter, among the travel data 500, travel data indicating an accelerating state of the vehicle 203 may be indicated as “travel data 500a”.

The executing unit 803, with respect to the identified motion data indicating an accelerating state of the mobile object, performs comparison with identified motion data that does not indicate an accelerating state of the mobile object, and executes detection of road surface unevenness by a reduced sensitivity. Motion data that does not indicate an accelerating state of the mobile object, for example, is motion data that indicates a constant speed state of the mobile object.

The executing unit 803, for example, with respect to the travel data 500a among the travel data 500 and identified by the identifying unit 802 to indicate an accelerating state of the vehicle 203, performs detection of road surface unevenness, by a sensitivity that corresponds to the accelerating state. The executing unit 803, more specifically, for example, when the travel data 500a indicating an accelerating state is identified, multiplies the vertical acceleration included in the travel data 500a and the accelerator correction coefficient Pa-b, to reduce the absolute value of the vertical acceleration included in the travel data 500a.

Thereafter, the executing unit 803 compares the reduced absolute value of the vertical acceleration included in the travel data 500a and the road surface unevenness detection threshold to thereby, detect road surface unevenness. Here, the executing unit 803 determines that road surface unevenness is present at a point indicated by the longitude and latitude, when the reduced absolute value of the vertical acceleration included in the travel data 500a is greater than the road surface unevenness detection threshold.

Further, the executing unit 803, more specifically, for example, may increase the road surface unevenness detection threshold, and compare the increased road surface unevenness detection threshold and the absolute value of the vertical acceleration included in the travel data 500a to detect road surface unevenness. Here, the executing unit 803 determines that road surface unevenness is present at a point indicated by the longitude and latitude, when the absolute value of the vertical acceleration included in the travel data 500a is greater than the increased road surface unevenness detection threshold. Further, if travel data 500a indicating an accelerating state is identified, the executing unit 803 may exclude the travel data 500a from the road surface unevenness detection.

Thus, with respect to the road surface traveled on by the vehicle 203, the executing unit 803 executes unevenness detection at a sensitivity that corresponds to the speed of the vehicle 203 and can accurately detect road surface unevenness by taking into consideration the effects of the travel status of the vehicle 203 on the detection of road surface unevenness.

The output unit 804 outputs the road surface unevenness location detected by the executing unit 803. The output unit 804, more specifically, for example, executes display to a display, output of an alarm, printout to a printer, and/or transmission to an external terminal. Thus, the output unit 804 can notify the user of the unevenness analyzer 201 of the road surface unevenness location. As a result, the user of the unevenness analyzer 201 can refer to the notified road surface unevenness location, analyze the degradation state of the road surface, and determine a repair plan for the road surface.

Operations corresponding to a brake section will be described. Operations corresponding to a brake section are operations of setting the sensitivity of the unevenness detection to be lower than in a case of operations corresponding to a constant speed section, and detecting road surface unevenness of the measured section from the travel data 500.

The receiving unit 801 performs processing similar to that in operations corresponding to an accelerator section and therefore, description is omitted. Thus, the receiving unit 801 can obtain the travel data 500 for detecting road surface unevenness.

The identifying unit 802 identifies motion data indicating a decelerating state of the mobile object, based on the motion status of the mobile object indicated by the mobile object motion data that includes at least longitudinal acceleration of the mobile object. The identifying unit 802, for example, identifies motion data that indicates a decelerating state of the vehicle 203, based on the travel status of the vehicle 203 indicated by the travel data 500 of the vehicle 203.

The identifying unit 802, more specifically, for example, separates the travel data 500 received by the receiving unit 801 into measured sections, and for each measured section, determines whether the measured section is a brake section to thereby identify the travel status of the vehicle 203. The identifying unit 802 identifies among the travel data 500, travel data that indicates a decelerating state of the vehicle 203.

The identifying unit 802, more specifically, for example, based on a temporal change in the longitudinal acceleration included in the travel data for the first measured section, among the travel data 500, determines whether the first measured section is a brake section. Here, the identifying unit 802 determines that the first measured section is a brake section, when each longitudinal acceleration included in the travel data 500 for the first measured section is the non-brake longitudinal acceleration Pb-a or greater. The identifying unit 802, when determining that the first measured section is a brake section, identifies among the travel data 500, the travel data for the first measured section to be travel data indicating a decelerating state of the vehicle 203.

Thus, the executing unit 803 can perform detection of road surface unevenness, by a sensitivity that corresponds to the traveling state identified by the identifying unit 802. In the description hereinafter, among the travel data 500, travel data that indicates a decelerating state of the vehicle 203 may be indicated as “travel data 500b”.

The executing unit 803, with respect to the identified motion data indicating a decelerating state of the mobile object, performs comparison with identified motion data that does not indicate a decelerating state of the mobile object, and executes detection of road surface unevenness by a reduced sensitivity. Motion data that does not indicate a decelerating state of the mobile object, for example, is motion data that indicates a constant speed state of the mobile object.

The executing unit 803, for example, with respect to the travel data 500b among the travel data 500 and identified by the identifying unit 802 to indicate a decelerating state of the vehicle 203, performs detection of road surface unevenness, by a sensitivity that corresponds to the decelerating state. The executing unit 803, more specifically, for example, when the travel data 500b indicating a decelerating state is identified, multiplies the vertical acceleration included in the travel data 500b and the brake correction coefficient Pb-b, to reduce the absolute value of the vertical acceleration included in the travel data 500b.

Thereafter, the executing unit 803 compares the reduced absolute value of the vertical acceleration included in the travel data 500b and the road surface unevenness detection threshold, and detects road surface unevenness. Here, the executing unit 803 determines that road surface unevenness is present at a point indicated by the longitude and latitude, when the reduced absolute value of the vertical acceleration included in the travel data 500b is greater than the road surface unevenness detection threshold.

Further, the executing unit 803, more specifically, for example, may increase the road surface unevenness detection threshold, and compare the increased road surface unevenness detection threshold and the absolute value of the vertical acceleration included in the travel data 500b to detect road surface unevenness. Here, the executing unit 803 determines that road surface unevenness is present at a point indicated by the longitude and latitude, when the absolute value of the vertical acceleration included in the travel data 500b is greater than the increased road surface unevenness detection threshold. Further, if travel data 500b indicating a decelerating state is identified, the executing unit 803 may exclude the travel data 500b from the road surface unevenness detection.

Thus, with respect to the road surface traveled on by the vehicle 203, the executing unit 803 executes unevenness detection at a sensitivity that corresponds to the speed of the vehicle 203 and can accurately detect road surface unevenness by taking into consideration the effects of the travel status of the vehicle 203 on the detection of road surface unevenness.

The output unit 804 performs processing similar to that in operations corresponding to an accelerator section and therefore, description is omitted. Thus, the output unit 804 can notify the user of the unevenness analyzer 201 of the road surface unevenness locations. As a result, the user of the unevenness analyzer 201 can refer to the notified road surface unevenness location, analyze the degradation state of the road surface, and determine a repair plan for the road surface.

Operations corresponding to a right_curve section will be described. Operations corresponding to a right_curve section are operations of setting the sensitivity of the unevenness detection to be lower than in a case of operations corresponding to a constant speed section, and detecting road surface unevenness of the measured section from the travel data 500.

The receiving unit 801 receives mobile object motion data that includes at least lateral acceleration of the mobile object. The receiving unit 801, for example, similar to the processing in operations corresponding to an accelerator section, receives the travel data 500 from the travel data measuring device 202. Thus, the receiving unit 801 can obtain the travel data 500 for detecting road surface unevenness.

The identifying unit 802 identifies motion data indicating travel along a curve by the mobile object, based on the motion status of the mobile object indicated by the mobile object motion data that includes at least lateral acceleration of the mobile object. The identifying unit 802, for example, identifies motion data that indicates travel along a right_curve by the vehicle 203, based on the travel status of the vehicle 203 indicated by the travel data 500 of the vehicle 203.

The identifying unit 802, more specifically, for example, separates the travel data 500 received by the receiving unit 801 into measured sections, and for each measured section, determines whether the measured section is a right_curve section to thereby identify the travel status of the vehicle 203. The identifying unit 802 identifies among the travel data 500, travel data that indicates travel along a right_curve by the vehicle 203.

The identifying unit 802, more specifically, for example, based on a temporal change in the lateral acceleration included in the travel data 500 for the first measured section, determines whether the first measured section is a right_curve section. Here, the identifying unit 802 determines that the first measured section is a right_curve section, when each lateral acceleration included in the travel data 500 for the first measured section is the right_curve lateral acceleration Pr-a or greater.

The identifying unit 802, when determining that the first measured section is a right_curve section, identifies among the travel data 500, the travel data for the first measured section to be travel data indicating travel along a right curve by the vehicle 203.

Thus, the executing unit 803 can perform detection of road surface unevenness, by a sensitivity that corresponds to the traveling state identified by the identifying unit 802. In the description hereinafter, among the travel data 500, travel data that indicates travel along a right curve by the vehicle 203 may be indicated as “travel data 500r”.

The executing unit 803, with respect to the identified motion data indicating travel along a curve by the mobile object, performs comparison with identified motion data that does not indicate travel along a curve by the mobile object, and executes detection of road surface unevenness by a reduced sensitivity. Motion data that does not indicate travel along a curve by the mobile object, for example, is motion data that indicates a constant speed state of the mobile object.

The executing unit 803, for example, with respect to the travel data 500r among the travel data 500 and identified by the identifying unit 802 to indicate travel along a right curve by the vehicle 203, performs detection of road surface unevenness, by a sensitivity that corresponds to the turning right state. The executing unit 803, more specifically, for example, when the travel data 500r indicating travel along a right curve by the vehicle 203 is identified, multiplies the vertical acceleration included in the travel data 500r and the right_curve correction coefficient Pr-b, to reduce the absolute value of the vertical acceleration included in the travel data 500r.

Thereafter, the executing unit 803 compares the reduced absolute value of the vertical acceleration included in the travel data 500r and the road surface unevenness detection threshold, and detects road surface unevenness. Here, the executing unit 803 determines that road surface unevenness is present at a point indicated by the longitude and latitude, when the reduced absolute value of the vertical acceleration included in the travel data 500r is greater than the road surface unevenness detection threshold.

Further, the executing unit 803, more specifically, for example, may increase the road surface unevenness detection threshold, and compare the increased road surface unevenness detection threshold and the absolute value of the vertical acceleration included in the travel data 500r to detect road surface unevenness. Here, the executing unit 803 determines that road surface unevenness is present at a point indicated by the longitude and latitude, when the absolute value of the vertical acceleration included in the travel data 500r is greater than the increased road surface unevenness detection threshold. Further, if travel data 500r indicating an accelerating state is identified, the executing unit 803 may exclude the travel data 500r from the road surface unevenness detection.

Thus, with respect to the road surface traveled on by the vehicle 203, the executing unit 803 executes unevenness detection at a sensitivity that corresponds to the velocity of the vehicle 203 and can accurately detect road surface unevenness by taking into consideration the effects of the travel status of the vehicle 203 on the detection of road surface unevenness.

The output unit 804 performs processing similar to that in operations corresponding to an accelerator section and therefore, description is omitted. Thus, the output unit 804 can notify the user of the unevenness analyzer 201 of the road surface unevenness locations. As a result, the user of the unevenness analyzer 201 can refer to the notified road surface unevenness location, analyze the degradation state of the road surface, and determine a repair plan for the road surface.

Operations corresponding to a left_curve section will be described. Operations corresponding to a left_curve section are operations of setting the sensitivity of the unevenness detection to be lower than in a case of operations corresponding to a constant speed section, and detecting road surface unevenness of the measured section from the travel data 500.

The receiving unit 801 performs processing similar to that in operations corresponding to a right_curve section and therefore, description is omitted. Thus, the receiving unit 801 can obtain the travel data 500 for detecting road surface unevenness.

The identifying unit 802 identifies motion data indicating travel along a curve by the mobile object, based on the motion status of the mobile object indicated by the mobile object motion data that includes at least lateral acceleration of the mobile object. The identifying unit 802, for example, identifies motion data that indicates travel along a left curve by the vehicle 203, based on the travel status of the vehicle 203 indicated by the travel data 500 of the vehicle 203.

The identifying unit 802, more specifically, for example, separates the travel data 500 received by the receiving unit 801 into measured sections, and for each measured section, determines whether the measured section is a left_curve section to thereby identify the travel status of the vehicle 203. The identifying unit 802 identifies among the travel data 500, travel data that indicates travel along a left curve by the vehicle 203.

The identifying unit 802, more specifically, for example, based on a temporal change in the lateral acceleration included in the travel data 500 for the first measured section, determines whether the first measured section is a left_curve section. Here, the identifying unit 802 determines that the first measured section is a left_curve section, when each lateral acceleration included in the travel data 500 for the first measured section is the left_curve lateral acceleration Pl-a or greater.

The identifying unit 802, when determining that the first measured section is a left_curve section, identifies among the travel data 500, travel data for the first measured section to be travel data indicating travel along a left curve by the vehicle 203.

Thus, the executing unit 803 can perform detection of road surface unevenness, by a sensitivity that corresponds to the traveling state identified by the identifying unit 802. In the description hereinafter, among the travel data 500, travel data that indicates travel along a left_curve by the vehicle 203 may be indicated as “travel data 5001”.

The executing unit 803, with respect to the identified motion data indicating travel along a curve by the mobile object, performs comparison with identified motion data that does not indicate travel along a curve by the mobile object, and executes detection of road surface unevenness by a reduced sensitivity.

The executing unit 803, for example, with respect to the travel data 5001 among the travel data 500 and identified by the identifying unit 802 to indicate travel along a left curve by the vehicle 203, performs detection of road surface unevenness, by a sensitivity that corresponds to the turning left state. The executing unit 803, more specifically, for example, when the travel data 5001 indicating travel along a left curve by the vehicle 203 is identified, multiplies the vertical acceleration included in the travel data 5001 and the left_curve correction coefficient Pl-b, to reduce the absolute value of the vertical acceleration included in the travel data 5001.

Thereafter, the executing unit 803 compares the reduced absolute value of the vertical acceleration included in the travel data 5001 and the road surface unevenness detection threshold, and detects road surface unevenness. Here, the executing unit 803 determines that road surface unevenness is present at a point indicated by the longitude and latitude, when the reduced absolute value of the vertical acceleration included in the travel data 5001 is greater than the road surface unevenness detection threshold.

Further, the executing unit 803, more specifically, for example, may increase the road surface unevenness detection threshold, and compare the increased road surface unevenness detection threshold and the absolute value of the vertical acceleration included in the travel data 5001 to detect road surface unevenness. Here, the executing unit 803 determines that road surface unevenness is present at a point indicated by the longitude and latitude, when the absolute value of the vertical acceleration included in the travel data 5001 is greater than the increased road surface unevenness detection threshold. Further, if travel data 5001 indicating an accelerating state is identified, the executing unit 803 may exclude the travel data 5001 from the road surface unevenness detection.

Thus, with respect to the road surface traveled on by the vehicle 203, the executing unit 803 executes unevenness detection at a sensitivity that corresponds to the velocity of the vehicle 203 and can accurately detect road surface unevenness by taking into consideration the effects of the travel status of the vehicle 203 on the detection of road surface unevenness.

The output unit 804 performs processing similar to that in operations corresponding to an accelerator section and therefore, description is omitted. Thus, the output unit 804 can notify the user of the unevenness analyzer 201 of the road surface unevenness locations. As a result, the user of the unevenness analyzer 201 can refer to the notified road surface unevenness location, analyze the degradation state of the road surface, and determine a repair plan for the road surface.

Operations corresponding to a constant speed section will be described. Operations corresponding to a constant speed section are operations of detecting road surface unevenness of the measured section from the travel data 500.

The receiving unit 801 performs processing similar to that in operations corresponding to an accelerator section and therefore, description is omitted. Thus, the receiving unit 801 can obtain the travel data 500 for detecting road surface unevenness.

The identifying unit 802 identifies the first measured section to be a constant speed section, when the first measured section is not identified to be a brake section, an accelerator section, a right_curve section, or a left_curve section. The identifying unit 802, when determining that the first measured section is a constant speed section, identifies among the travel data 500, travel data for the first measured section to be travel data indicating a constant speed state of the vehicle 203.

Thus, the executing unit 803 can perform detection of road surface unevenness, by a sensitivity that corresponds to the traveling state identified by the identifying unit 802. In the description hereinafter, among the travel data 500, travel data that indicates a constant speed state of the vehicle 203 may be indicated as “travel data 500s”.

The executing unit 803, with respect to the identified motion data indicating a constant speed state of the mobile object, executes detection of road surface unevenness, by a sensitivity that is lowered or increased according to the speed of the vehicle 203. The executing unit 803, for example, when the travel data 500s indicating a constant speed state is identified, multiplies the vertical acceleration included in the travel data 500s and a correction coefficient (Ps-a to Ps-d) corresponding to the speed of the vehicle 203, to reduce or increase the absolute value of the vertical acceleration included in the travel data 500s.

The executing unit 803, more specifically, for example, when the speed of the vehicle 203 is 50 km/h or less, increases the absolute value of the vertical acceleration included in the travel data 500 and when the speed of the vehicle 203 is 81 km/h or greater, reduces the absolute value of the vertical acceleration included in the travel data 500.

Thereafter, the executing unit 803 compares the reduced/increased absolute value of the vertical acceleration included in the travel data 500s and the road surface unevenness detection threshold, and detects road surface unevenness. Here, the executing unit 803 determines that road surface unevenness is present at a point indicated by the longitude and latitude, when the reduced/increased absolute value of the vertical acceleration included in the travel data 500s is greater than the road surface unevenness detection threshold.

Further, the executing unit 803, for example, may correct the road surface unevenness detection threshold according to the speed of the vehicle 203, and compare the corrected road surface unevenness detection threshold and the absolute value of the vertical acceleration in travel data 500 to detect road surface unevenness. Here, the executing unit 803 determines that road surface unevenness is present at a point indicated by the longitude and latitude, when the absolute value of the vertical acceleration included in the travel data 500s is greater than the corrected road surface unevenness detection threshold.

Thus, with respect to the road surface traveled on by the vehicle 203, the executing unit 803 executes unevenness detection at a sensitivity that corresponds to the speed of the vehicle 203 and can accurately detect road surface unevenness by taking into consideration the effects of the travel status of the vehicle 203 on the detection of road surface unevenness.

The output unit 804 performs processing similar to that in operations corresponding to an accelerator section and therefore, description is omitted. Thus, the output unit 804 can notify the user of the unevenness analyzer 201 of the road surface unevenness locations. As a result, the user of the unevenness analyzer 201 can refer to the notified road surface unevenness location, analyze the degradation state of the road surface, and determine a repair plan for the road surface.

Operations corresponding to composite acceleration will be described. Operations corresponding to composite acceleration are operations of determining road surface unevenness for each measured section of the travel data 500 based on composite acceleration, which is a combination of the longitudinal, lateral, and vertical acceleration.

The receiving unit 801 receives mobile object motion data that includes at least longitudinal, lateral, and vertical acceleration of the mobile object. The receiving unit 801, for example, similar to the processing in operations corresponding to an accelerator section, receives the travel data 500 from the travel data measuring device 202. Thus, the receiving unit 801 can obtain the travel data 500 for detecting road surface unevenness.

The identifying unit 802, based on the mobile object motion data that includes at least longitudinal, lateral, and vertical acceleration of the mobile object, extracts motion data having a vertical acceleration value that indicates a predetermined movement. For example, when among longitudinal acceleration values in the travel data 500 for the first measured section, a value that is a threshold or less is included, the identifying unit 802 identifies the travel data of the first measured section as travel data that indicates a predetermined movement.

Thus, with respect to travel data identified by the identifying unit 802, the executing unit 803 can determine whether a road surface is uneven, based on the composite acceleration in the forward, backward, leftward, rightward, upward, and downward directions. In the description hereinafter, among the travel data 500, travel data that indicates a predetermined movement may be indicated as “travel data 500h”.

In the extracted motion data, the executing unit 803 determines that a road surface is uneven with respect to motion data for which the sum of longitudinal, lateral, and vertical acceleration is a predetermined value or greater. In the extracted motion data, the executing unit 803, for example, determines that a depression is present on a left side of a road surface with respect to motion data that includes acceleration in a backward direction, acceleration in a leftward direction, and acceleration in a downward direction, and for which the sum is the predetermined value or greater.

In the extracted motion data, the executing unit 803, for example, determines that a depression is present on a right side of a road surface with respect to motion data that includes acceleration in a backward direction, acceleration in a rightward direction, and acceleration in a downward direction, and for which the sum is the predetermined value or greater.

In the extracted motion data, the executing unit 803, for example, determines that a protrusion is present on a left side of a road surface with respect to motion data that includes acceleration in a forward direction, acceleration in a rightward direction, and acceleration in an upward direction, and for which the sum is the predetermined value or greater.

In the extracted motion data, the executing unit 803, for example, determines that a protrusion is present on a right side of a road surface with respect to motion data that includes acceleration in a forward direction, acceleration in a leftward direction, and acceleration in an upward direction, and for which the sum is the predetermined value or greater.

The executing unit 803, more specifically, for example, identifies patterns of combinations of the positive and negative signs of longitudinal, lateral, and vertical acceleration at each measuring point for travel data of the vehicle 203 in each section. A pattern, for example, is the left side depression pattern, the right side depression pattern, the left side protrusion pattern, and the right side protrusion pattern depicted in FIG. 7. The executing unit 803, when identifying one of the patterns, determines if the absolute value of the sum of longitudinal, lateral, and vertical acceleration is a composite acceleration product Ph-at or greater.

The executing unit 803, when determining that the absolute value of the sum is the composite acceleration product Ph-at or greater, determines that with respect to the extracted travel data 500h, road surface unevenness of the shape and at the position corresponding to the identified pattern is present.

The executing unit 803, when determining that the absolute value of the sum is the composite acceleration product Ph-at or greater, may multiply the vertical acceleration included in the travel data 500h and the left_curve correction coefficient Pl-b to increase the absolute value of the vertical acceleration included in the travel data 500h.

Thereafter, the executing unit 803 compares the increased absolute value of the vertical acceleration included in the travel data 500h and the road surface unevenness detection threshold and thereby, detects road surface unevenness. Here, the executing unit 803 determines that road surface unevenness is present at a point indicated by the longitude and latitude, when the increased absolute value of the vertical acceleration included in the travel data 500h is greater than the road surface unevenness detection threshold.

The executing unit 803, more specifically, for example, may increase the road surface unevenness detection threshold and compare the increased road surface unevenness detection threshold and the absolute value of the vertical acceleration included in the travel data 500h to detect road surface unevenness. Here, the executing unit 803 determines that road surface unevenness is present at a point indicated by the longitude and latitude, when the absolute value of the vertical acceleration included in the travel data 500h is greater than the increased road surface unevenness detection threshold.

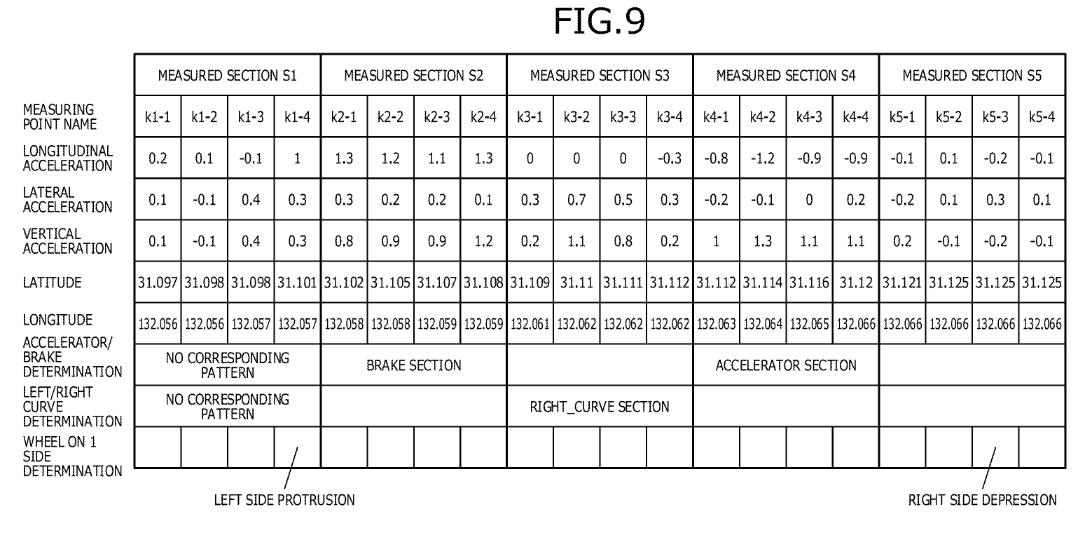

An example of the unevenness analysis method according to the second embodiment will be described with reference to FIG. 9.

FIG. 9 is a diagram depicting an example of the unevenness analysis method according to the second embodiment, for road surfaces. In the example depicted in FIG. 9, the vehicle 203 is assumed to travel at a constant speed to a measured section S1, and around k1-4, the left front wheel is assumed to run over a protrusion on the left side of the road surface. Subsequently, the vehicle 203 is assumed to brake in a measured section S2 and to turn right along a right curve at a slow constant speed in a measured section S3. The vehicle 203 is assumed to accelerate around k4-1 at the end of a turn in a measured section S4, travel at a constant speed in a measured section S5, and around k5-3, and run over a depression on the right side of the road surface by the right front wheel. Here, as described above, the unevenness analyzer 201 receives the travel data 500 of the vehicle 203 and detects for road surface unevenness.

The unevenness analyzer 201, based on the analysis parameter 600, multiplies a measuring point count “4” of measuring points in the measured section and the non-accelerator longitudinal acceleration Pa-a “−0.8”, to calculate an accelerator acceleration determining product Pa-c “−3.2”. The unevenness analyzer 201 multiplies the measuring point count “4” of the measured section and the non-brake longitudinal acceleration Pb-a “1.1” to calculate a brake acceleration determining product Pb-c “4.4”.

The unevenness analyzer 201 multiplies the measuring point count “4” of the measured section and the right_curve lateral acceleration Pr-a “0.3” to calculate a right_curve acceleration determining product Pr-c “1.2”. The unevenness analyzer 201 multiplies the measuring point count “4” of the measured section and the left_curve lateral acceleration Pl-a “−0.4” to calculate a left_curve acceleration determining product Pl-c “−1.6”.

The unevenness analyzer 201, among the travel data 500, obtains the travel data of the measured section S1. The unevenness analyzer 201 calculates the sum of longitudinal acceleration for the measured section S1, “Σa=0.2+0.1−0.1+1=1.2”. The unevenness analyzer 201 determines whether Σa>Pb-c is true. Here, since Σa=1.2<Pb-c=4.4 and therefore, Σa>Pb-c is not true, the unevenness analyzer 201 determines that the measured section S1 is not a brake section.

The unevenness analyzer 201 determines whether Σa<Pa-c is true. Here, since Σa=1.2>Pa-c=−3.2 and therefore, Σa<Pa-c is not true, the unevenness analyzer 201 determines that the measured section S1 is not an accelerator section.

The unevenness analyzer 201 calculates the sum of the lateral acceleration for the measured section S1 “Σr=0.1−0.1+0.4+0.3=0.7”. The unevenness analyzer 201 determines whether Σr>Pr-c is true. Here, since Σn−1=0.7<Pr-c=1.2 and therefore, Σr>Pr-c is not true, the unevenness analyzer 201 determines that the measured section S1 is not a right_curve section.

The unevenness analyzer 201 determines whether Σr<Pl-c is true. Since, Σr=0.7>Pl-c=−1.6 and therefore, Σr<Pl-c is not true, the unevenness analyzer 201 determines that the measured section S1 is not a left_curve section.

At the measuring point k1-1, since the signs of the longitudinal, lateral, and vertical acceleration are respectively “+, +, +”, the unevenness analyzer 201 determines that the pattern is the left side protrusion pattern where the left front wheel has run over a protrusion. Here, the unevenness analyzer 201 calculates the sum of the absolute values of acceleration at k1-1, “Σp=0.2+0.1+0.1=0.4”, and since Σp is not greater than the composite acceleration product Ph-at, the unevenness analyzer 201 does not correct the vertical acceleration for the measuring point.

As a result, configuration can be such that even when the vehicle 203 travels on a road surface that has a protrusion of a left side protrusion pattern, if the composite acceleration is small, the unevenness analyzer 201 refrains from correcting the vertical acceleration and does not detect protrusions that need not be detected such as protrusions of a small shape. Consequently, the unevenness analyzer 201 can improve the accuracy of road surface unevenness detection.

At measuring point k1-2, since the signs are “+, −, −” respectively, the unevenness analyzer 201 determines that there is no corresponding pattern and does not correct the vertical acceleration for measuring point. At measuring point k1-3, since the signs are “−, +, +” respectively, the unevenness analyzer 201 determines that there is no corresponding pattern and does not correct the vertical acceleration for measuring point.

At measuring point k1-4, since the signs are “+, +, +” respectively, the unevenness analyzer 201 determines that the pattern is a left side protrusion pattern where the left front wheel has run over a protrusion. Here, the unevenness analyzer 201 calculates the sum of the absolute values of acceleration at measuring point k1-4, “Σp=1.0+0.3+0.3=1.6”, and determines that Σp is greater than the composite acceleration product Ph-at. Therefore, the unevenness analyzer 201 multiplies the vertical acceleration at the measuring point and the Ph-b “1.2” to amplify the vertical acceleration to “0.36”.

As a result, the unevenness analyzer 201 can identify the shape and position of unevenness, based on the backward force and rightward force resulting from the right side of the vehicle 203 becoming higher consequent to only the left front wheel running over the protrusion. Even when the vertical acceleration is smaller than that when both front wheels run over the protrusion, since only the left front wheel and not both front wheels run over the protrusion, the unevenness analyzer 201 can amplify the vertical acceleration so as to be detected as unevenness in the detection of road surface unevenness. Consequently, the unevenness analyzer 201 can improve the accuracy of road surface unevenness detection.

The unevenness analyzer 201, among the travel data 500, obtains the travel data for the measured section S2. Subsequently, the unevenness analyzer 201 calculates the sum of longitudinal acceleration for the measured section S2, “Σa=1.3+1.2+1.1+1.3=4.9”. The unevenness analyzer 201 determines whether Σa>Pb-c is true. Here, since Σa=4.9>Pb-c=4.4, the unevenness analyzer 201 determines that the measured section S2 is a brake section candidate.

Since the longitudinal acceleration at each measuring point in the measured section S2 is Pb-a “1.1” or greater, the unevenness analyzer 201 confirms that the measured section S2 is a brake section. Since the measured section S2 is confirmed to be a brake section, the unevenness analyzer 201 omits determination concerning an accelerator section, a right_curve section, and a left_curve section. The unevenness analyzer 201 multiplies the vertical acceleration at each of the four measuring points k2-1 to k2-4 by Pb-b “0.8”.

As a result, even when the vertical acceleration is large consequent to the vehicle 203 sinking as a result of the vehicle 203 continuously braking in the measured section S2, the unevenness analyzer 201 can reduce the vertical acceleration so as to take the effects of braking into consideration. Consequently, the unevenness analyzer 201 can improve the accuracy of road surface unevenness detection.

The unevenness analyzer 201, among the travel data 500, obtains the travel data for the measured section S3. Subsequently, the unevenness analyzer 201 calculates the sum of longitudinal acceleration for the measured section S3, “Σa=0+0+0−0.3=−0.3”.

Similar to the case of the measured section S1, since Σa=−0.3<Pb-c=4.4 and therefore, Σa>Pb-c is not true, the unevenness analyzer 201 determines that the measured section S3 is not a brake section. Similar to the case of the measured section S1, since Σa=−0.3>Pa-c=−3.2 and therefore, Σa<Pa-c is not true, the unevenness analyzer 201 determines that the measured section S3 is not an accelerator section.

The unevenness analyzer 201 calculates the sum of lateral acceleration for the measured section S3 “Σr=0.3+0.7+0.5+0.3=1.8”. The unevenness analyzer 201 determines whether Σr>Pr-c is true. Here, since Σr=1.8>Pr-c=1.2, the unevenness analyzer 201 determines that the measured section S3 is a right_curve section candidate.

Subsequently, since the lateral acceleration at each measuring point in the measured section S3 is Pr-a “0.3” or greater, the unevenness analyzer 201 confirms that the measured section S3 is a right_curve section. Since the measured section S3 is confirmed to be a right_curve section, the unevenness analyzer 201 omits determination concerning a left_curve section. The unevenness analyzer 201 multiplies the vertical acceleration at each of the four measuring points k3-1 to k3-4 by Pr-b “0.6”.

As a result, even when vertical acceleration is large consequent to the right side of the vehicle 203 sinking when the vehicle 203 turns right along a right curve in the measured section S3, the unevenness analyzer 201 can reduce the vertical acceleration so as to take the effects of turning right into consideration. Consequently, the unevenness analyzer 201 can improve the accuracy of road surface unevenness detection.

The unevenness analyzer 201, among the travel data 500, obtains the travel data for the measured section S4. Subsequently, the unevenness analyzer 201 calculates the sum of longitudinal acceleration for the measured section S4, “Σa=−0.8−1.2−0.9−0.9=−3.8”. Similar to the case of the measured section S1, since Σa=−3.8<Pb-c=4.4 and therefore, Σa>Pb-c is not true, the unevenness analyzer 201 determines that the measured section S3 is not a brake section.

The unevenness analyzer 201 determines whether Σa<Pa-c is true. Here, since Σa=−3.8<Pa-c=−3.2, the unevenness analyzer 201 determines that the measured section S4 is an accelerator section candidate.

Subsequently, since the longitudinal acceleration at each measuring point in the measured section S4 is Pa-a “−0.8” or less, the unevenness analyzer 201 confirms that the measured section S4 is an accelerator section. Since the measured section S4 is confirmed to be an accelerator section, the unevenness analyzer 201 omits determination concerning a right_curve section and a left_curve section. The unevenness analyzer 201 multiplies the vertical acceleration at each of the four measuring points k4-1 to k4-4 by Pa-b “0.7”.

As a result, even when the vertical acceleration is large consequent to the vehicle 203 sinking when the accelerator of the vehicle 203 continues to be applied in the measured section S4, the unevenness analyzer 201 can reduce the vertical acceleration so as to take the effects of the accelerator into consideration. Consequently, the unevenness analyzer 201 can improve the accuracy of road surface unevenness detection.

The unevenness analyzer 201, among the travel data 500, obtains the travel data for the measured section S5. Subsequently, the unevenness analyzer 201 calculates the sum of longitudinal acceleration for the measured section S5, “Σa=−0.1+0.1−0.2−0.1=−0.3”.

Similar to the case of the measured section S1, since Σa=−0.3<Pb-c=4.4 and therefore, Σa>Pb-c is not true, the unevenness analyzer 201 determines that the measured section S5 is not a brake section. Further, similar to the case of the measured section S1, since Σa=−0.3>Pa-c=−3.2 and therefore, Σa<Pa-c is not true, the unevenness analyzer 201 determines that the measured section S5 is not an accelerator section.

The unevenness analyzer 201 calculates the sum of lateral acceleration for the measured section S5, “Σr=−0.2+0.1+0.3+0.1=0.3”. Similar to the case for the measured section S1, since Σr=0.3<Pr-c=1.2 and therefore, Σr>Pr-c is not true, the unevenness analyzer 201 determines that the measured section S5 is not a right_curve section. Further, similar to the case of the measured section S1, since Σr=0.3>Pl-c=−1.6 and therefore, Σr<Pl-c is not true, the unevenness analyzer 201 determines that the measured section S5 is not a left_curve section.

Since the signs at measuring point k5-1 are “−, −+” respectively, the unevenness analyzer 201 determines that there is no corresponding pattern and does not correct the vertical acceleration for the measuring point. Further, since the signs at measuring point k5-2 are “+, +, −” respectively, the unevenness analyzer 201 determines that there is no corresponding pattern and does not correct the vertical acceleration for the measuring point.

Further, since the signs at measuring point k5-3 are “−, +, −” respectively, the unevenness analyzer 201 determines that the pattern is the right side depression pattern where the right front wheel has run over a depression. Here, the unevenness analyzer 201 calculates the sum of the absolute values of acceleration at measuring point k5-3, “Σp=0.2+0.3+0.2=0.7”, and determines that Σp is greater than the composite acceleration product Ph-at. Therefore, the unevenness analyzer 201 multiplies the vertical acceleration at the measuring point by Ph-b “1.2” to amplify the vertical acceleration to “−0.24”.

As a result, the unevenness analyzer 201 can identify the shape and position of unevenness, based on the forward force and the rightward force resulting from the right front side of the vehicle 203 becoming lower consequent to only the right front wheel running over the depression. Even when the vertical acceleration is smaller than when both front wheels run over the depression since only the right front wheel and not both front wheels run over the depression, the unevenness analyzer 201 can amplify the vertical acceleration so as to be detected as unevenness in the detection of road surface unevenness. Consequently, the unevenness analyzer 201 can improve the accuracy of road surface unevenness detection.

Since the signs at measuring point k5-4 are “−, +, −” respectively, the unevenness analyzer 201 determines that the pattern is a pattern where the right front wheel has run over a depression. Here, the unevenness analyzer 201 calculates the sum of the absolute values of acceleration at measuring point k5-4, “Σp=0.1+0.1+0.1=0.3”, and since Σp is not greater than the composite acceleration product Ph-at, the unevenness analyzer 201 does not correct the vertical acceleration for the measuring point.

As a result, configuration can be such that even when the vehicle 203 travels on a road surface that has a depression of a right side depression pattern, if the composite acceleration is small, the unevenness analyzer 201 refrains from correcting the vertical acceleration and does not detect depressions that need not be detected such as depressions of a small shape. Consequently, the unevenness analyzer 201 can improve the accuracy of road surface unevenness detection.

As described, among the travel data 500, the unevenness analyzer 201 corrects the vertical acceleration with respect to travel data for each section and thereafter, makes a comparison with the road surface unevenness detection threshold to detect road surface unevenness to thereby, perform analysis of road surface unevenness with high accuracy. The unevenness analyzer 201 correlates and stores results of the road surface unevenness detection with the travel data 500 and can thereby notify the user of the unevenness analyzer 201 of the positions of road surface unevenness.

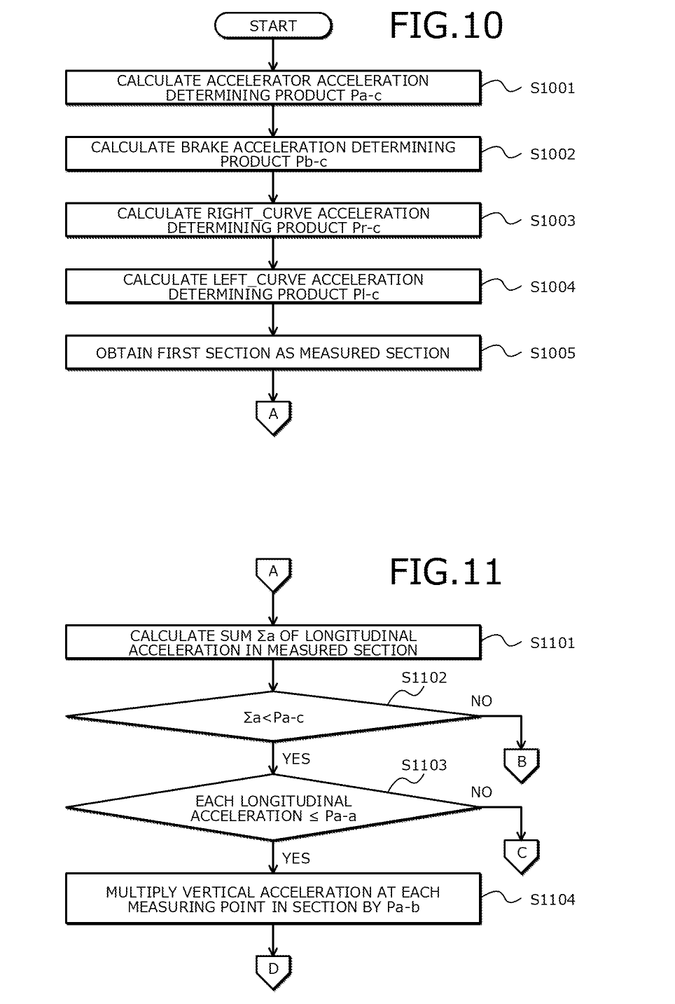

An example of a procedure of a road surface unevenness analysis process by the unevenness analyzer 201 will be described with reference to FIGS. 10 to 14.

FIGS. 10, 11, 12, 13, and 14 are flowcharts of an example of a procedure of the road surface unevenness analysis process. In FIG. 10, the unevenness analyzer 201 multiplies the measuring point count for a measured section and the non-accelerator longitudinal acceleration Pa-a to calculate the accelerator acceleration determining product Pa-c (step S1001). The unevenness analyzer 201 multiplies the measuring point count for the measured section and the non-brake longitudinal acceleration Pb-a to calculate the brake acceleration determining product Pb-c (step S1002).

The unevenness analyzer 201 multiplies the measuring point count for the measured section and the right_curve lateral acceleration Pr-a to calculate the right_curve acceleration determining product Pr-c (step S1003). The unevenness analyzer 201 multiplies the measuring point count for the measured section and the left_curve lateral acceleration Pl-a to calculate the left_curve acceleration determining product Pl-c (step S1004). The unevenness analyzer 201 obtains the first section as the measured section (step S1005), and transitions to the operation at step S1101 depicted in FIG. 11.

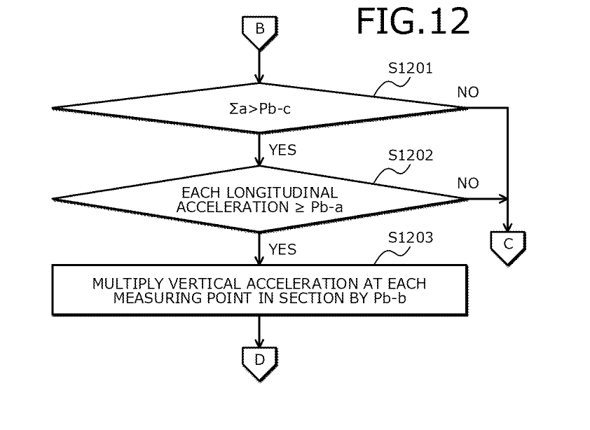

In FIG. 11, the unevenness analyzer 201 calculates the sum Σa of longitudinal acceleration in the obtained measured section (step S1101). The unevenness analyzer 201 determines whether Σa is less than the accelerator acceleration determining product Pa-c (step S1102). If Σa is not less than the accelerator acceleration determining product Pa-c (step S1102: NO), the unevenness analyzer 201 transitions to the operation at step S1201 depicted in FIG. 12.

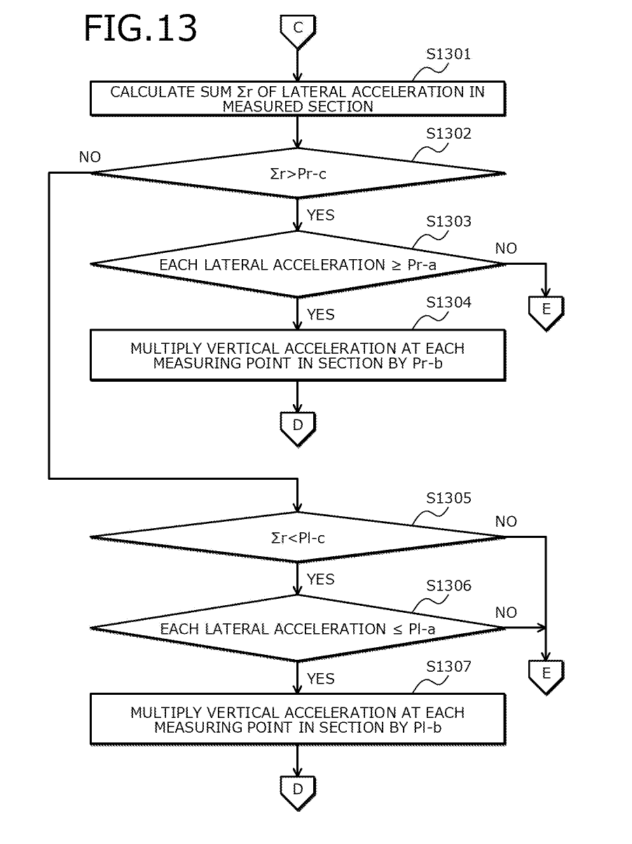

If Σa is less than the accelerator acceleration determining product Pa-c (step S1102: YES), the unevenness analyzer 201 determines if each longitudinal acceleration in the measured section is the non-accelerator longitudinal acceleration Pa-a or less (step S1103). If each longitudinal acceleration is not the non-accelerator longitudinal acceleration Pa-a or less (step S1103: NO), the unevenness analyzer 201 transitions to the operation at step S1301 depicted in FIG. 13.

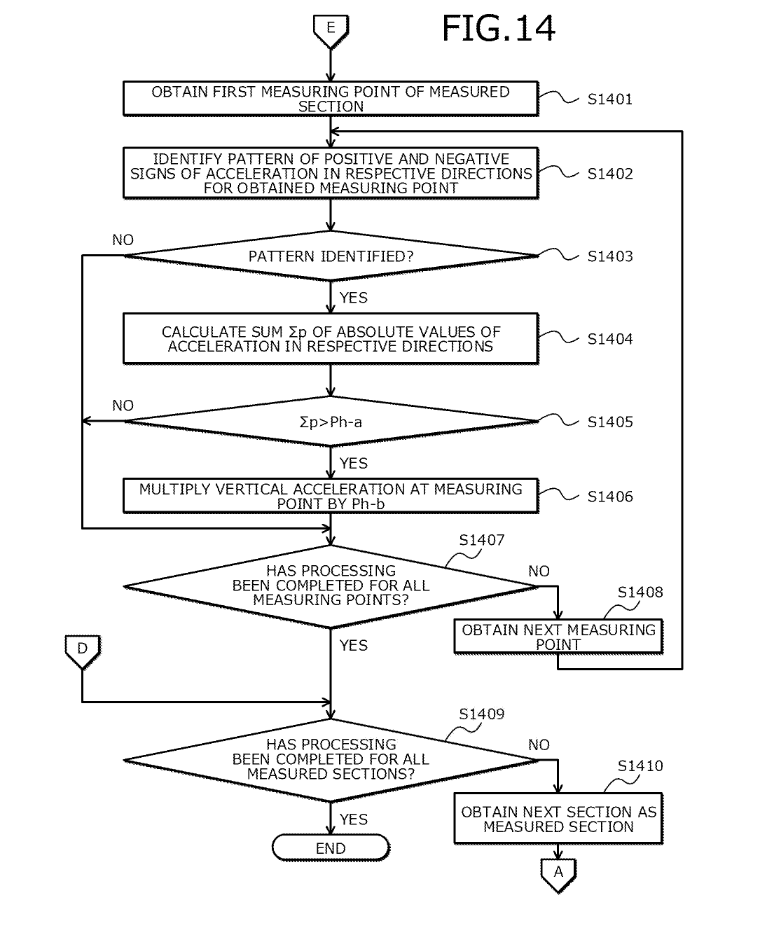

If each longitudinal acceleration is the non-accelerator longitudinal acceleration Pa-a or less (step S1103: YES), the unevenness analyzer 201 multiplies the vertical acceleration at each measuring point in the section by the accelerator correction coefficient Pa-b (step S1104). The unevenness analyzer 201 transitions to the operation at step S1409 depicted in FIG. 14.

In FIG. 12, the unevenness analyzer 201 determines whether Σa is greater than the brake acceleration determining product Pb-c (step S1201). If Σa is not greater than the brake acceleration determining product Pb-c (step S1201: NO), the unevenness analyzer 201 transitions to the operation at step S1301 depicted in FIG. 13.

If Σa is greater than the brake acceleration determining product Pb-c (step S1201: YES), the unevenness analyzer 201 determines if each longitudinal acceleration in the measured section is the non-brake longitudinal acceleration Pb-a or greater (step S1202). If each longitudinal acceleration in the measured section is not the non-brake longitudinal acceleration Pb-a or greater (step S1202: NO), the unevenness analyzer 201 transitions to the operation at step S1301 depicted in FIG. 13.

If each longitudinal acceleration in the measured section is the non-brake longitudinal acceleration Pb-a or greater (step S1202: YES), the unevenness analyzer 201 multiplies the vertical acceleration at each measuring point in the section by the brake correction coefficient Pb-b (step S1203). The unevenness analyzer 201 transitions to the operation at step S1409 depicted in FIG. 14.

In FIG. 13, the unevenness analyzer 201 calculates the sum Σr of lateral acceleration in the obtained measured section (step S1301). The unevenness analyzer 201 determines whether Σr is greater than the right_curve acceleration determining product Pr-c (step S1302).

If Σr is greater than the right_curve acceleration determining product Pr-c (step S1302: YES), the unevenness analyzer 201 determines if each lateral acceleration in the measured section is the right_curve lateral acceleration Pr-a or greater (step S1303). If each lateral acceleration is not the right_curve lateral acceleration Pr-a or greater (step S1303: NO), the unevenness analyzer 201 transitions to the operation at step S1401 depicted in FIG. 14.

If each lateral acceleration is the right_curve lateral acceleration Pr-a or greater (step S1303: YES), the unevenness analyzer 201 multiplies the vertical acceleration at each measuring point in the section by the right_curve correction coefficient Pr-b (step S1304). The unevenness analyzer 201 transitions to the operation at step S1409 depicted in FIG. 14.

At step S1302, if Σr is not greater than the right_curve acceleration determining product Pr-c (step S1302: NO), the unevenness analyzer 201 determines whether Σr is less than the left_curve acceleration determining product Pl-c (step S1305). If Σr is not less than the left_curve acceleration determining product Pl-c (step S1305: NO), the unevenness analyzer 201 transitions to the operation at step S1401 depicted in FIG. 14.

If Σr is less than the left_curve acceleration determining product Pl-c (step S1305: YES), the unevenness analyzer 201 determines if each lateral acceleration in the measured section is the left_curve lateral acceleration Pl-a or less (step S1306). If each lateral acceleration is not the left_curve lateral acceleration Pl-a or less (step S1306: NO), the unevenness analyzer 201 transitions to the operation at step S1401 depicted in FIG. 14.

If each lateral acceleration is the left_curve lateral acceleration Pl-a or less (step S1306: YES), the unevenness analyzer 201 multiplies the vertical acceleration at each measuring point in the section by the left_curve correction coefficient Pl-b (step S1307). The unevenness analyzer 201 transitions to the operation at step S1409 depicted in FIG. 14.

In FIG. 14, the unevenness analyzer 201 obtains the first measuring point of the obtained measured section (step S1401). Subsequently, the unevenness analyzer 201 identifies the pattern of positive and negative signs of the longitudinal, lateral, and vertical acceleration at the obtained measuring point (step S1402).

The unevenness analyzer 201 determines whether a pattern depicted in FIG. 7 is identified (step S1403). If no pattern is identified (step S1403: NO), the unevenness analyzer 201 transitions to the operation at step S1407.

If a pattern is identified (step S1403: YES), the unevenness analyzer 201 calculates the sum Σp of the absolute values of acceleration in the respective directions (step S1404). The unevenness analyzer 201 determines whether Σp is greater than the composite acceleration product Ph-at (step S1405). If Σp is not greater than the composite acceleration product Ph-at (step S1405: NO), the unevenness analyzer 201 transitions to the operation at step S1407.

If Σp is greater than the composite acceleration product Ph-at (step S1405: YES), the unevenness analyzer 201 multiplies the vertical acceleration at the measuring point by the composite correction coefficient Ph-b (step S1406). The unevenness analyzer 201 determines whether processing has been completed for each measuring point (step S1407). If processing has not been completed (step S1407: NO), the unevenness analyzer 201 obtains the next measuring point (step S1408), and returns to the operation at step S1402.

If processing has been completed (step S1407: YES), the unevenness analyzer 201 determines whether processing has been completed for each measured section (step S1409). If processing has not been completed (step S1409: NO), the unevenness analyzer 201 obtains the next section as the measured section (step S1410), and returns to the operation at step S1101 depicted in FIG. 11.

If processing has been completed (step S1409: YES), the unevenness analyzer 201 ends the road surface unevenness analysis process. Thus, the unevenness analyzer 201 can correct the travel data 500. The unevenness analyzer 201 can further detect road surface unevenness, based on the corrected travel data 500.

Here, in the described flowcharts, the operations depicted in FIG. 11 are the operations corresponding to an accelerator section described above; the operations depicted in FIG. 12 are the operations corresponding to a brake section described above; the operations depicted in FIG. 13 are the operations corresponding to a right_curve section and the operations corresponding to a left_curve section described above; and the operations depicted in FIG. 14 are the operations corresponding to composite acceleration described above.

As described above, according to the unevenness analyzer 201 of the second embodiment, based on the traveling state of the vehicle 203 indicated by the travel data 500, travel data indicating an accelerating state can be identified from among the travel data 500 and road surface unevenness detection can be performed by a reduced sensitivity. As a result, even when vertical acceleration is large consequent to the vehicle 203 sinking when the accelerator of the vehicle 203 is applied in the measured section, the unevenness analyzer 201 can reduce the vertical acceleration so as to take into consideration the effects of the accelerator and improve the accuracy of road surface unevenness detection.

According to the unevenness analyzer 201 of the second embodiment, based on the traveling state of the vehicle 203 indicated by the travel data 500, travel data indicating a decelerating state can be identified from among the travel data 500 and road surface unevenness detection can be performed by a reduced sensitivity. As a result, even when vertical acceleration is large consequent to the vehicle 203 sinking when the brake of the vehicle 203 is applied in the measured section, the unevenness analyzer 201 can reduce the vertical acceleration so as to take into consideration the effects of the brake and improve the accuracy of road surface unevenness detection.

According to the unevenness analyzer 201 of the second embodiment, based on the traveling state of the vehicle 203 indicated by the travel data 500, travel data indicating a turning right state can be identified from among the travel data 500 and road surface unevenness detection can be performed by a reduced sensitivity. As a result, even when vertical acceleration is large consequent to the right side of the vehicle 203 sinking when the vehicle 203 turns along a right curve in the measured section, the unevenness analyzer 201 can reduce the vertical acceleration so as to take into consideration the effects of turning right and improve the accuracy of road surface unevenness detection.

According to the unevenness analyzer 201 of the second embodiment, based on the traveling state of the vehicle 203 indicated by the travel data 500, travel data indicating a turning left state can be identified from among the travel data 500 and road surface unevenness detection can be performed by a reduced sensitivity. As a result, even when vertical acceleration is large consequent to the left side of the vehicle 203 sinking when the vehicle 203 turns along a left curve in the measured section, the unevenness analyzer 201 can reduce the vertical acceleration so as to take into consideration the effects of turning left and improve the accuracy of road surface unevenness detection.

For example, according to the unevenness analyzer 201 of the second embodiment, when acceleration in either the left or right direction is a predetermined value or greater, a state where the vehicle 203 is moving around a curve can be identified. As a result, the unevenness analyzer 201 can identify the state to be a state where the vehicle 203 has turned along a right curve or a left curve in the measured section.

Further, according to the unevenness analyzer 201 of the second embodiment, concerning measuring points for which the composite acceleration of the longitudinal, lateral, and vertical acceleration is a predetermined value or greater, unevenness detection can be executed by a sensitivity that is made higher than that for a constant speed, straight traveling state. As a result, the unevenness analyzer 201 can take into consideration the effects of the position and shape of road surface unevenness on road surface unevenness detection and perform analysis of road surface unevenness with high accuracy.

According to the unevenness analyzer 201 of the second embodiment, based on the pattern of the positive and negative signs of longitudinal acceleration, lateral acceleration, and vertical acceleration, the position and shape of road surface unevenness can be identified. In addition to identifying the position and shape of unevenness, the unevenness analyzer 201 further takes into consideration the effects of the position and shape of the road surface unevenness on road surface unevenness detection and thus, can analyze road surface unevenness with high accuracy.

For example, when only the left front wheel runs over a depression, the unevenness analyzer 201 can determine that a depression on the left side of the road surface is present by the left side depression pattern resulting when the left front side of the vehicle 203 becomes lower, applying a force forward and a force toward the left. In addition to identifying the position and shape of unevenness, the unevenness analyzer 201 takes into consideration the effects of the position and shape of the road surface unevenness on road surface unevenness detection and thus, can perform analysis of road surface unevenness with high accuracy.

For example, when only the right front wheel runs over a depression, the unevenness analyzer 201 can determine that a depression on the right side of the road surface is present by the right side depression pattern resulting when the right front side of the vehicle 203 becomes lower, applying a force forward and a force toward the right. In addition to identifying the position and shape of unevenness, the unevenness analyzer 201 takes into consideration the effects of the position and shape of the road surface unevenness on road surface unevenness detection and thus, can perform analysis of road surface unevenness with high accuracy.

For example, when only the left front wheel runs over a protrusion, the unevenness analyzer 201 can determine that a protrusion on the left side of the road surface by the left side protrusion pattern resulting when the left front side of the vehicle 203 becomes higher, applying a force backward and a force toward the right. In addition to identifying the position and shape of unevenness, the unevenness analyzer 201 takes into consideration the position and shape of the road surface unevenness on road surface unevenness detection and thus, can perform analysis of road surface unevenness with high accuracy.

For example, even when only the right front wheel runs over a protrusion, the unevenness analyzer 201 can determine that a protrusion on the right side of the road surface is present by the right side protrusion pattern resulting when the right front side of the vehicle 203 becomes higher, applying a force backward and a force toward the left. In addition to identifying the position and shape of unevenness, the unevenness analyzer 201 takes into consideration the position and shape of the road surface unevenness on road surface unevenness detection and thus, can perform analysis of road surface unevenness with high accuracy.

Here, a case where a conventional unevenness analyzer obtains only vertical acceleration and detects road surface unevenness is conceivable. Nonetheless, in this case, the conventional unevenness analyzer cannot discern whether vertical acceleration is large consequent to the vehicle 203 running over unevenness or vertical acceleration is large consequent to the vehicle 203 being in an accelerating state, a decelerating state, a turning right state, or a turning left state. Therefore, irrespective of no unevenness actually being present on the road surface of a section traveled by the vehicle 203 in various states, the conventional unevenness analyzer may errantly detect road surface unevenness. On the other hand, according to the unevenness analyzer 201 of the present embodiments, based on longitudinal acceleration, lateral acceleration, etc., each traveling state is identified, and with respect to travel data of a section traveled by the vehicle 203 in various traveling states, unevenness detection can be executed lowering the sensitivity of detection. As a result, the unevenness analyzer 201 is configured to enable road surface unevenness to not be detected when no unevenness in a road surface is actually present.

Here, a case where a conventional unevenness analyzer obtains only vertical acceleration and detects road surface unevenness is conceivable. Nonetheless, in this case, if the conventional unevenness analyzer detects road surface unevenness assuming the vertical acceleration when the vehicle 203 runs over road surface unevenness with wheels on both sides, the conventional unevenness analyzer may be unable to detect road surface unevenness in some instances. For example, the conventional unevenness analyzer may be unable to detect the road surface unevenness when the vehicle 203 runs over unevenness with only the left front wheel, since the vertical acceleration becomes smaller. Further, if the conventional unevenness analyzer detects road surface unevenness assuming the vertical acceleration when the vehicle 203 runs over unevenness with only the left front wheel, the conventional unevenness analyzer may detect road surface unevenness that is small and needs not be detected. For example, when the vehicle 203 runs over road surface unevenness with wheels on both sides, the vertical acceleration becomes larger and therefore, the conventional unevenness analyzer may detect road surface unevenness that is small and needs not be detected. On the other hand, according to the unevenness analyzer 201 of the present embodiments, based on the composite acceleration, when the vertical acceleration becomes smaller irrespective of the vehicle 203 running over unevenness, unevenness detection can be executed by a sensitivity that has been increased. As a result, the unevenness analyzer 201 can improve the accuracy of road surface unevenness detection.

Here, conventionally, it is conceivable that a person observes recorded images from a vehicle-equipped camera, identifies each traveling state, identifies travel data of a section traveled by the vehicle 203 in various traveling states, and concerning the travel data, lowers the sensitivity and executes unevenness detection. Further, it is conceivable that a person observes recorded images from a vehicle-equipped camera, determines whether the vehicle 203 ran over unevenness with wheels on both sides or ran over unevenness with one front wheel, and concerning travel data for a point where the vehicle 203 ran over unevenness with only one front wheel, lowers the sensitivity and executes unevenness detection. Nonetheless, in this case, the work of observing recorded images manually consumes time and much time is consumed for detecting road surface unevenness. Further, in this case, the accuracy of the road surface unevenness detection decreases if the person errantly identifies the traveling state, errantly determines that unevenness was run over by one front wheel, etc. On the other hand, according to the unevenness analyzer 201 of the present embodiments, identification of the traveling state of the vehicle 203, etc., changing of the sensitivity, and the unevenness detection can be executed automatically. As a result, the unevenness analyzer 201 can suppress increases in the time consumed for detecting road surface unevenness.

The unevenness analysis method described in the present embodiments can be implemented by executing a prepared program on a computer such as a personal computer and work station. The unevenness analysis program is stored to a computer-readable recording medium such as a hard disk, a flexible disk, CD-ROM, MO, and DVD and is executed by being read from the recording medium by a computer. Further, the unevenness analysis program may be distributed via a network such as the Internet.

According to one aspect of the invention, an effect is achieved in that the detection accuracy of road surface unevenness can be improved.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory, computer-readable recording medium storing therein an unevenness analysis program that causes a computer to perform based on an analysis parameter, analysis of motion data of a mobile object and analysis of unevenness of a road surface traveled by the mobile object, the unevenness analysis program causing the computer to execute a process comprising:
identifying by the computer and based on a motion status of the mobile object indicated by the motion data, which includes at least longitudinal acceleration of the mobile object, first motion data that indicates one of an accelerating state and a decelerating state of the mobile object; and
executing by the computer and with respect to the identified first motion data indicating one of an accelerating state and a decelerating state, a comparison with second motion data not indicating one of an accelerating state and a decelerating state, and detection of unevenness of the road surface by a reduced sensitivity.

2. A non-transitory, computer-readable recording medium storing therein an unevenness analysis program that causes a computer to perform based on an analysis parameter, analysis of motion data of a mobile object and analysis of unevenness of a road surface traveled by the mobile object, the unevenness analysis program causing the computer to execute a process comprising:
identifying by the computer and based on a motion status of the mobile object indicated by the motion data, which includes at least lateral acceleration of the mobile object, first motion data that indicates that the mobile object is moving around a curve; and
executing by the computer and with respect to the identified first motion data indicating that the mobile object is moving around a curve, a comparison with second motion data not indicating that the mobile object is moving around a curve, and detection of unevenness of the road surface by a reduced sensitivity.

3. The non-transitory, computer-readable recording medium according to claim 2, the process further comprising
determining by the computer, that the mobile object is moving around a curve when at a speed that is at least a predetermined value, one of a leftward direction and a rightward direction indicates acceleration that is at least a predetermined value, wherein
the identifying includes identifying based on a result of the determining, the first motion data that indicates that the mobile object is moving around a curve.

4. The non-transitory, computer-readable recording medium according to claim 2, wherein
the motion data further includes longitudinal acceleration of the mobile object,
the identifying includes identifying based on the motion status of the mobile object indicated by the motion data, third motion data that indicates one of an accelerating state and a decelerating state of the mobile object, and
the executing includes executing with respect to the third motion data, a comparison with fourth motion data that does not indicate one of an accelerating state and a decelerating state of the mobile object, and executing the detection of unevenness of the road surface by a reduced sensitivity.

5. The non-transitory, computer-readable recording medium according to claim 1, wherein
the motion data further includes vertical acceleration of the mobile object,
the executing includes executing the detection of unevenness of the road surface by performing correction such that an absolute value of the vertical acceleration indicated by the identified motion data becomes smaller, and comparing the corrected vertical acceleration with a predetermined threshold.

6. A non-transitory, computer-readable recording medium storing therein an unevenness analysis program causing a computer to perform based on an analysis parameter, analysis of motion data of a mobile object and analysis of unevenness of a road surface traveled by the mobile object, the unevenness analysis program causing the computer to execute a process comprising:
extracting, by the computer and based on a motion status of the mobile object indicated by the motion data, which includes at least longitudinal, lateral, and vertical acceleration of the mobile object, first motion data in which a value of the vertical acceleration indicates a predetermined movement; and
determining that unevenness of the road surface is present, with respect to second motion data that is in the extracted first motion data and for which a sum of the longitudinal, the lateral, and the vertical acceleration is at least a predetermined value, the determining being performed by the computer.

7. The non-transitory, computer-readable recording medium according to claim 6, wherein
the determining includes determining that a depression on a left side of the road surface is present, with respect to third motion data that is in the extracted first motion data, includes backward, leftward, and downward acceleration, and for which the sum is at least the predetermined value.

8. The non-transitory, computer-readable recording medium according to claim 6, wherein
the determining includes determining that a depression on a right side of the road surface is present, with respect to fourth motion data that is in the extracted first motion data, includes backward, rightward, and downward acceleration, and for which the sum is at least the predetermined threshold.

9. The non-transitory, computer-readable recording medium according to claim 6, wherein
the determining includes determining that a protrusion on a left side of the road surface is present, with respect to fifth motion data that is in the extracted first motion data, includes forward, rightward, and upward acceleration, and for which the sum is at least the predetermined value.

10. The non-transitory, computer-readable recording medium according to claim 6, wherein
the determining includes determining that a protrusion on a right side of the road surface is present, with respect to sixth motion data that is in the extracted first motion data, includes forward, leftward, and upward acceleration, and for which the sum of is at least a predetermined value.

11. The non-transitory, computer-readable recording medium according to claim 6, the process further comprising:
identifying by the computer and based on the motion status of the mobile object indicated by the motion data, seventh motion data that indicates one of an accelerating state and a decelerating state of the mobile object; and
executing by the computer and with respect to the identified seventh motion data, a comparison with eighth motion data that does not indicate one of an accelerating state and a decelerating state of the mobile object, and executing by the computer, detection of unevenness of the road surface by a reduced sensitivity.

12. The non-transitory, computer-readable recording medium according to claim 11, wherein
the extracting includes extracting based on the motion status of the mobile object indicated by the motion data, the first motion data that is the eighth motion data.

13. The non-transitory, computer-readable recording medium according to claim 6, the process further comprising:
identifying by the computer and based on the motion status of the mobile object indicated by the motion data, ninth motion data that indicates that the mobile object is moving around a curve; and
executing by the computer and with respect to the identified ninth motion data that indicates that the mobile object is moving around a curve, a comparison with tenth motion data that does not indicate that the mobile object is moving around a curve, and executing by the computer, detection of unevenness of the road surface by a reduced sensitivity.

14. The non-transitory, computer-readable recording medium according to claim 13, wherein
the extracting includes extracting based on the motion status of the mobile object indicated by the motion data, the first motion data that is the tenth motion data.

15. An unevenness analysis method of performing based on an analysis parameter, analysis of motion data of a mobile object and analysis of unevenness of a road surface traveled by the mobile object, the unevenness analysis method comprising:
identifying by the computer and based on a motion status of the mobile object indicated by the motion data, which includes at least longitudinal acceleration of the mobile object, first motion data that indicates one of an accelerating state and a decelerating state of the mobile object; and
executing by the computer and with respect to the identified first motion data indicating one of an accelerating state and a decelerating state, a comparison with second motion data not indicating one of an accelerating state and a decelerating state, and detection of unevenness of the road surface by a reduced sensitivity.

16. An unevenness analysis method of performing based on an analysis parameter, analysis of motion data of a mobile object and analysis of unevenness of a road surface traveled by the mobile object, the unevenness analysis method comprising:
identifying by the computer and based on a motion status of the mobile object indicated by the motion data, which includes at least lateral acceleration of the mobile object, first motion data that indicates that the mobile object is moving around a curve; and
executing by the computer and with respect to the identified first motion data indicating that the mobile object is moving around a curve, a comparison with second motion data not indicating that the mobile object is moving around a curve, and detection of unevenness of the road surface by a reduced sensitivity.

17. An unevenness analysis method of performing based on an analysis parameter, analysis of motion data of a mobile object and analysis of unevenness of a road surface traveled by the mobile object, the unevenness analysis method comprising:
extracting, by the computer and based on a motion status of the mobile object indicated by the motion data, which includes at least longitudinal, and lateral, and vertical acceleration of the mobile object, first motion data in which a value of the vertical acceleration indicates a predetermined movement; and
determining that unevenness of the road surface is present, with respect to second motion data that is in the extracted first motion data and for which a sum of the longitudinal, the lateral, and the vertical acceleration is at least a predetermined value, the determining being performed by the computer.

18. An unevenness analyzer that performs based on an analysis parameter, analysis of motion data of a mobile object and analysis of unevenness of a road surface traveled by the mobile object, the unevenness analyzer comprising:
a control circuit configured to identify based on a motion status of the mobile object indicated by the motion data, which includes at least longitudinal acceleration of the mobile object, first motion data that indicates one of an accelerating state and a decelerating state of the mobile object; and execute with respect to the identified first motion data indicating one of an accelerating state and a decelerating state, a comparison with second motion data not indicating one of an accelerating state and a decelerating state, and detection of unevenness of the road surface by a reduced sensitivity.

19. An unevenness analyzer that performs based on an analysis parameter, analysis of motion data of a mobile object and analysis of unevenness of a road surface traveled by the mobile object, the unevenness analyzer comprising:
a control circuit configured to identify based on a motion status of the mobile object indicated by the motion data, which includes at least lateral acceleration of the mobile object, first motion data that indicates that the mobile object is moving around a curve; and execute with respect to the identified first motion data indicating that the mobile object is moving around a curve, a comparison with second motion data not indicating that the mobile object is moving around a curve, and detection of unevenness of the road surface by a reduced sensitivity.

20. An unevenness analyzer that performs based on an analysis parameter, analysis of motion data of a mobile object and analysis of unevenness of a road surface traveled by the mobile object, the unevenness analyzer comprising:
a control circuit configured to extract based on a motion status of the mobile object indicated by the motion data, which includes at least longitudinal, lateral, and vertical acceleration of the mobile object, first motion data in which a value of the vertical acceleration indicates a predetermined movement; and determine that unevenness of the road surface is present, with respect to second motion data that is in the extracted first motion data and for which a sum of the longitudinal, the lateral, and the vertical acceleration is at least a predetermined value.

21. The non-transitory, computer-readable recording medium according to claim 2, wherein
the motion data further includes vertical acceleration of the mobile object,
the executing includes executing the detection of unevenness of the road surface by performing correction such that an absolute value of the vertical acceleration indicated by the identified motion data becomes smaller, and comparing the corrected vertical acceleration with a predetermined threshold.
